(19) United States
(12) Patent Application Publication
(10) Pub. No.: US 2014/0019212 A1
(43) Pub. Date: Jan. 16, 2014

(54) SYSTEMS AND METHODS FOR FACILITATING MIGRATION AND ADOPTION OF AN ALTERNATIVE COMPUTING INFRASTRUCTURE

(71) Applicant: Exoprise Systems Inc., Waltham, MA (US)

(72) Inventors: Jason Lieblich, Lincoln, MA (US); Carl Shimer, Westborough, MA (US); Clinton Blackburn, Dallas, TX (US)

(73) Assignee: Exoprise Systems Inc., Waltham, MA (US)

(21) Appl. No.: 14/026,656

(22) Filed: Sep. 13, 2013

Related U.S. Application Data
(62) Division of application No. 13/075,965, filed on Mar. 30, 2011.
(60) Provisional application No. 61/318,892, filed on Mar. 30, 2010.

(51) Int. Cl. G06Q 10/06

(52) U.S. Cl. CPC G06Q 10/0637
USPC 705/7.36

(57) ABSTRACT

The present disclosure is directed to, among other things, a method that selecting, by a processor, user accounts on a first computing infrastructure to migrate to a second computing infrastructure; provisioning, by the processor, a parallel user account on the second computing infrastructure for each of the user accounts on the first computing infrastructure; and migrating, by the processor, information from the user accounts on the first computing infrastructure to the parallel user accounts.

### RELATED APPLICATIONS

The present disclosure claims priority to U.S. Provisional Application No. 61/318,892, entitled “Systems and Methods for Facilitating Migration and Adopt of Internet-Based Applications and Services” and filed Mar. 30, 2010, which is hereby incorporated by reference in its entirety.

The present disclosure is related to U.S. Application No. _____, entitled “Systems and Methods for Selecting an Alternative Computing Infrastructure” and filed Mar. 30, 2011.

### BACKGROUND

Improving and/or replacing a computing infrastructure may be a complicated process. Obtaining data about a computing infrastructure and analyzing the data to evaluate options for the infrastructure may be expensive and time-consuming.

### SUMMARY OF THE DISCLOSURE

In some aspects, the present disclosure is directed to a method. The method may include selecting, by a processor, user accounts on a first computing infrastructure to migrate to a second computing infrastructure. The method may include provisioning, by the processor, a parallel user account on the second computing infrastructure for each of the user accounts on the first computing infrastructure. The method may include migrating, by the processor, information from the user accounts on the first computing infrastructure to the parallel user accounts.

The second computing infrastructure may include a cloud-based computing infrastructure. Selecting the user accounts may include selecting the user accounts based on use metrics. Selecting the user accounts may include selecting the user accounts based on interactions between users associated with the user accounts. Migrating the information from the user accounts may include migrating at least one of documents or electronic communications from the user accounts on the first computing infrastructure to the parallel user accounts.

The method may include transmitting, by the processor, an invitation to a user associated with a selected user account to participate in migration; and receiving, by the processor, a response to the invitation indicating consent by the user. The method may include transmitting, by the processor, a training program for the second computing infrastructure to the user; and receiving, by the processor, information about progress of the user through the training program. The method may include deprovisioning, by the processor, the user accounts on the first computing infrastructure. The method may include reverse migrating, by the processor, at least a portion of the information from the parallel user accounts to the user accounts on the first computing infrastructure.

The method may include repurposing, by the processor, a resource of the first computing infrastructure according to a capacity of the resource. The method may include decommissioning, by the processor, a resource of the first computing infrastructure according to a capacity of the resource. The method may include measuring, by the processor, a delivery time for an electronic communication transmitted between the user accounts on the first computing infrastructure to determine an estimate of a standard delivery time. The method may include estimating, by the processor, a period of time to migrate the information from a user account on the first computing infrastructure to the parallel user account. The method may include estimating, by the processor, a period of time to reverse migrate the information from a parallel user account to a user account on the first computing infrastructure.

The method may include testing, by the processor, the parallel user accounts. Testing the parallel user accounts may include transmitting an electronic communication to a parallel user account; accessing the parallel user account; and verifying the electronic communication arrived at the parallel user account. Testing the parallel user accounts may include transmitting an electronic communication from a user account on the first computing infrastructure to a parallel user account; and measuring a time between the transmitting and receipt of the electronic communication. The method may include evaluating, by the processor, a subsystem on the second computing infrastructure when the time is longer than a predetermined period of time. Testing the parallel user accounts may include monitoring login activity of the parallel user accounts.

In some aspects, the present disclosure is directed to another method. The method may include selecting, by a processor, user accounts on an installation computing infrastructure to migrate to a cloud-based computing infrastructure based on at least one of: i) use metrics of the user accounts, or ii) interactions between users of the user accounts. The method may include provisioning, by the processor, a parallel user account on the cloud-based computing infrastructure for each of the user accounts on the installation computing infrastructure. The method may include migrating, by the processor, information from the user accounts on the installation computing infrastructure to the parallel user accounts. The method may include testing, by the processor, the parallel user accounts. The method may include deprovisioning, by the processor, the user accounts on the installation computing infrastructure.

In some aspects, the present disclosure is directed to a system with a processor and a memory. The memory may store instructions that, when executed by the processor, cause the processor to: select user accounts on a first computing infrastructure to migrate to a second computing infrastructure; provision a parallel user account on the second computing infrastructure for each of the user accounts on the first computing infrastructure; and migrate information from the user accounts on the first computing infrastructure to the parallel user accounts.

The second computing infrastructure may comprise a cloud-based computing infrastructure. Selecting the user accounts may include selecting the user accounts based on use metrics. Selecting the user accounts may include selecting the user accounts based on interactions between users associated with the user accounts. Migrating the information from the user accounts may include migrating at least one of documents or electronic communications from the user accounts on the first computing infrastructure to the parallel user accounts.

The memory may store instructions that, when executed by the processor, further cause the processor to transmit an invitation to a user associated with a selected user account to participate in migration; and receive a response to the invitation indicating consent by the user. The memory further stores instructions that, when executed by the processor, further cause the processor to transmit a training program for the second computing infrastructure to the user; and receive information about progress of the user through the training program. The memory may store instructions that, when executed by the processor, further cause the processor to deprovision the user accounts on the first computing infrastructure.

The memory may store instructions that, when executed by the processor, further cause the processor to reverse migrate at least a portion of the information from the parallel user accounts to the user accounts on the first computing infrastructure. The memory may store instructions that, when executed by the processor, further cause the processor to repurpose a resource of the first computing infrastructure according to a capacity of the resource.

The memory may store instructions that, when executed by the processor, further cause the processor to decommission a resource of the first computing infrastructure according to a capacity of the resource. The memory may store instructions that, when executed by the processor, further cause the processor to measure a delivery time for an electronic communication transmitted between the user accounts on the first computing infrastructure to determine an estimate of a standard delivery time. The memory may store instructions that, when executed by the processor, further cause the processor to estimate a period of time to migrate the information from a user account on the first computing infrastructure to the parallel user account. The memory may store instructions that, when executed by the processor, further cause the processor to estimate a period of time to reverse migrate the information from a parallel user account to a user account on the first computing infrastructure. The memory may store instructions that, when executed by the processor, further cause the processor to test the parallel user accounts.

Testing the parallel user accounts may include transmitting an electronic communication to a parallel user account; accessing the parallel user account; and verifying the electronic communication arrived at the parallel user account. Testing the parallel user accounts may include transmitting an electronic communication from a user account on the first computing infrastructure to a parallel user account; and measuring a time between the transmitting and receipt of the electronic communication.

The memory may store instructions that, when executed by the processor, further cause the processor to: evaluate a subsystem on the second computing infrastructure for the electronic communication when the time is longer than a predetermined period of time. Testing the parallel user accounts may include monitoring login activity of the parallel user accounts.

### BRIEF DESCRIPTION OF THE DRAWINGS

The foregoing and other objects, aspects, features, and advantages of the present invention will become more apparent and better understood by referring to the following description taken in conjunction with the accompanying drawings, in which:

FIG. 1 is a block diagram of an exemplary system for facilitating migration and adoption of network-based applications and services;

FIG. 2 is an exemplary computing device for a client or server used with the system of FIG. 1;

FIG. 3 is a flow diagram for an exemplary method of discovering and assessing data about a computing infrastructure to select an alternative computing infrastructure;

FIGS. 4-8 are exemplary user interfaces displayed by an agent that obtains data about a computing infrastructure;

FIGS. 9-12 are exemplary user interfaces associated with a report on the computing infrastructure and selected alternative computing infrastructure;

FIG. 13 is a flow diagram for an exemplary method of migrating users from a computing infrastructure to an alternative computing infrastructure and testing the success of the migration;

FIGS. 14-24 are exemplary user interfaces for configuring a migration, used in tandem with the method of FIG. 13;

FIGS. 29-30 are exemplary user interfaces for monitoring concurrent migrations, used in tandem with the method of FIG. 13;

FIGS. 31-33 are exemplary user interfaces for rolling back migrations, used in tandem with the method of FIG. 13; and

FIGS. 34-38 are exemplary user interfaces for configuring monitors for the computing infrastructures and/or viewing data obtained by monitoring, used in tandem with the method of FIG. 13.

### DETAILED DESCRIPTION

In general overview, the systems and methods described herein may be directed to facilitating the migration and adoption of a network-based infrastructure. The systems obtain information about a computing infrastructure used by an organization. Based on the information, the systems may identify an alternative network-based infrastructure to replace at least a portion of the computing infrastructure. The systems may migrate at least a portion of the computing infrastructure to the alternative. The systems may perform monitoring on the infrastructures during the migration or after the migration has been completed.

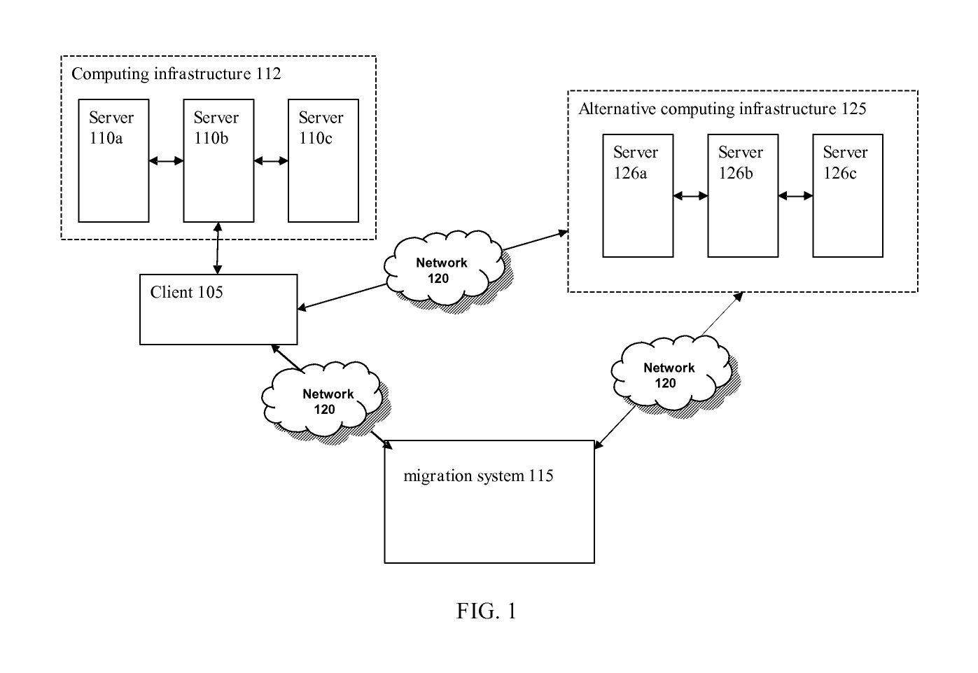

Referring now to FIG. 1, an exemplary system, according to some implementations, for facilitating migration and adoption of network-based applications and services is shown and described. A client 105 in communication with servers 110 (e.g., directory servers, e-mail servers, application servers, file servers) in a computing infrastructure 112 may connect to a migration system 115 (e.g., one or more servers) over a network 120 (e.g., the Internet). The client 105 may obtain a discovery and assessment tool from the migration system 115. The discovery and assessment tool may access the servers 110 in the computing infrastructure. The tool may obtain data about the servers 110, such as the configuration and/or use of the servers.

In some implementations, the tool may transmit the data to the migration system 115. The migration system 115 may analyze the data about the servers 110, e.g., calculate metrics about the computing infrastructure 112. The migration system 115 may evaluate the metrics against a plurality of alternative computing infrastructures (e.g., cloud-based infrastructures). Based on the evaluation, the migration system 115 may select an alternative computing infrastructure 125 to replace at least a portion of the computing infrastructure 112. The migration system 115 may generate a report with the analysis of the data and a description of the selected alternative computing infrastructure 125. The migration system 115 may transmit the report to the client 105 for display to, e.g., an administrator of the computing infrastructure 112. The migration system 115 may post the report on a website accessible by, e.g., an administrator at a client 105. The administrator may consider the report, e.g., to determine if migrating to the alternative infrastructure 125 is an appropriate action. In some implementations, consideration of the report may be automated according to, for example, software instructions.

Once the administrator decides to migrate the infrastructure 112, the migration system 115 may perform tests on user accounts to obtain performance characteristics of the computing infrastructure 112. In some implementations, the migration system 115 may select a group of user accounts to migrate. For each of the selected user accounts, the migration system 115 may provision a parallel user account on the alternative computing infrastructure 125. The migration system 115 may migrate information (e.g., documents, electronic communications, account settings) from the user accounts on the computing infrastructure 112 to the parallel user accounts.

During the migration or after the migration has been completed, the migration system 115 may perform tests on the user accounts on the computing infrastructure 112, the parallel user accounts on the alternative computing infrastructure 125, or both. In some implementations, tests performed during or after the migration may determine performance characteristics of the hybrid system, e.g., performance visible to the user when user accounts may be divided between the computing infrastructure 112 and the selected alternative 125. In some implementations, tests performed after all or some of the users accounts have been migrated to the selected alternative 125 may determine performance characteristics of the alternative computing infrastructure 125. In some implementations, the migration system 115 may deprovision user accounts on the original infrastructure 112.

The systems, software, and methods described herein may be implemented advantageously in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object oriented programming language, or in assembly or machine language if desired. In any case, the language may be a compiled or interpreted language. Suitable processors include, by way of example, both general and special purpose microprocessors. Generally, a processor (e.g., one or more processors) will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD ROM disks. Any of the foregoing may be supplemented by, or incorporated in, ASICs (application-specific integrated circuits).

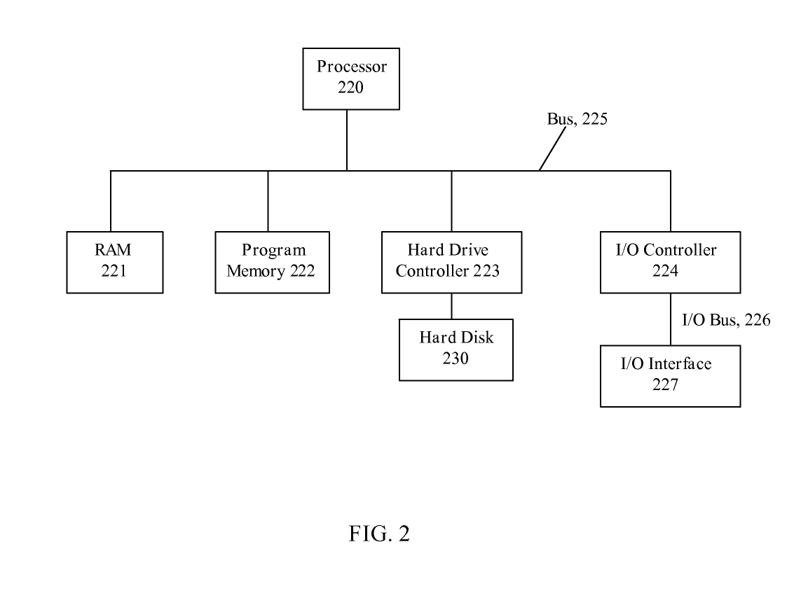

An example of one such type of computer is shown in FIG. 2, which shows a block diagram of a programmable processing system (system) 211 suitable for implementing or performing the apparatus or methods described herein. The system 211 includes a processor 220, a random access memory (RAM) 221, a program memory 222 (for example, a writeable read-only memory (ROM) such as a flash ROM), a hard drive controller 223, and an input/output (I/O) controller 224 coupled by a processor (CPU) bus 225. The system 211 may be preprogrammed, in ROM, for example, or it can be programmed (and reprogrammed) by loading a program from another source (for example, from a floppy disk, a CD-ROM, or another computer).

The hard drive controller 223 may be coupled to a hard disk 230 suitable for storing executable computer programs, including programs embodying the present methods, and data including storage. The I/O controller 224 may be coupled by an I/O bus 226 to an I/O interface 227. The I/O interface 227 may receive and transmit data in analog or digital form over communication links such as a serial link, local area network, wireless link, and parallel link.

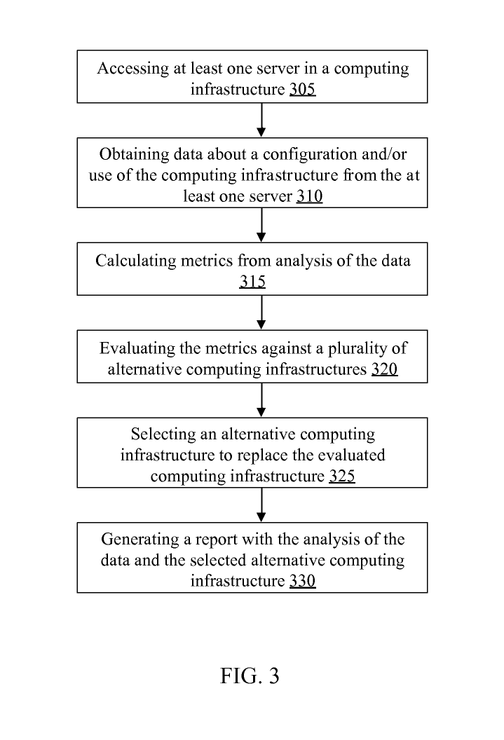

Referring now to FIG. 3, steps in an exemplary method for assessing a computing infrastructure for potential migration to an alternative computing infrastructure are shown and described. Although the steps are described in reference to the system of FIG. 1, the steps may be performed by other components capable of exercising the same or similar functionality. Although the steps are described in an order, in some implementations, the steps may be performed in other orders.

A client 105 may obtain a discovery and assessment tool (also referred to herein as an “agent”) from a migration system 115. In some implementations, the client 105 may download software code from the migration system 115 for installation. In some implementations, an administrator may obtain a storage medium (e.g., CD-ROM, flash drive) with the software code. The administrator may install the software code from the storage medium on the client 105 or a server 110 in the computing infrastructure 112. The client 105 may retrieve the code from its internal storage or the server 110 for execution.

In some implementations, the software code may be a plug-in for a web browser on the client 105. In some implementations, the software code may include extensions that result in modifications in functionality for a web Brower-based application. The extensions may allow code from a web site on the application to access the host computing device. Exemplary functionality enabled by the modifications and/or extensions abilities to access processes (e.g., start, stop, and/or terminate processes; monitor started and stopped processes), files (e.g. create, write to, delete, list, find, download, install, un-install, and/or remove files), archives (e.g., create compressed files, compress and/or uncompress files), registries (e.g., read and/or write to local and/or remote registries), networks (e.g., obtain elevated access to network stacks), or any combination thereof. In some implementations, the software code may be an application shell.

In some implementations, the agent may be an application installed on a server 110, a designated server 110 in the computing infrastructure 112 that communicates with other servers, or a server on a virtual private network (VPN) positioned between the computing infrastructure 112 and the alternative computing infrastructure 112. One or more processors on the server 110, designated server 110, or server on the VPN may execute the agent.

As the agent executes, the agent may access at least one server 110 in the computing infrastructure 112 (step 305). The agent may access any server 110 accessible in the computing infrastructure 112 via, for example, a local area network (LAN) such as a corporate LAN. In some implementations, the agent may access different servers 110 in the infrastructure 112. The agent may determine the servers 110 in the computing infrastructure 112. For example, the agent may determine, e.g., the servers involved in electronic communication, such as e-mail servers, application servers, mailbox servers, client access servers, unified messaging server, hub transport servers, mail transport servers, edge transport servers, or any other type of server as would be understood by one of ordinary skill in the art.

The agent may obtain data about the computing infrastructure 112 from the at least one server 110 (step 310). In some implementations, the agent may obtain information via Windows Management Instrumentation (WMI). In some implementations, the agent may obtain information via accessing remote registries, performance counters, Windows NT event log captures, and/or remote file system iteration. In some implementations, the agent may be a secure and/or remote shell that accesses the data.

In some implementations, the agent may poll servers 110 to obtain the data. The agent may obtain data over days, weeks, months, or any other period of time set by an administrator authorizing the agent's access to the computing infrastructure 110. In some implementations, an administrator may select a time of day for the data to be obtained (e.g., early morning hours).

The data may indicate the hardware resources used by the computing infrastructure 112. Data may indicate the configuration of servers 110 in the infrastructure 112, the configuration of the infrastructure 112, use of the infrastructure 112, or any other information as would be appreciated by one of ordinary skill in the art. In some implementations, data may include, for each server 110, e.g., information about the server's manufacturer, acquisition date, and hardware; peripheral devices attached to the server; size and storage types on the server; operating system and/or operating system cluster configuration; application server type; patches applied to the server (e.g., freshness, frequency of updates); power supplies used by the server; software installed on the server (e.g., backup, anti-spam, anti-virus, compliance, archival, monitoring); and/or network traffic received and/or sent with respect to the server.

Data may include, e.g., information on the organizational units for the organization (e.g., hierarchies of the units, people within the units and/or subdivisions), access control lists, permissions, login statistics, distribution lists (e.g., groups for electronic communications), service settings, service statistics, or any combination thereof.

Data may include, e.g., cluster and/or server settings, information about messaging (e.g., message types, recipient types, size and frequency of messages); or information about attachments to communications that are stored on the servers 110 (e.g., attachment types, edits and/or revisions to attachments). Data may include, e.g., information about communication, such as frequency of communications, sizes of communication inboxes, number of users at or near quota, number of heavy users, number of light users, internal and external recipients of communications, read receipts, importance indicators, sensitivity indicators, impersonation, responses on behalf of other parties, and/or group communication responsibilities. Data may include, e.g., information about spamming and filtering (e.g., vendors, reliability of applications, cost estimates, maintenance costs). Data may include, e.g., information about compliance add-ons (e.g., vendors, capacity, cost estimates). Data may include, e.g., information about archival add-ons (e.g., vendor, storage, capacity, cost estimates).

Data may include, e.g., for user accounts, rules per folder, information about user-created folders (e.g., folder depth, modification, age), statistics regarding replied and/or forwarded messages. Data may include, e.g., average and/or overall usage of the servers 110 by individual users or the amount of data on behalf of individual users stored on the servers 110.

Data may include, e.g., information on calendar items, frequency and/or types of collaboration via calendar applications (e.g., appointments per day, requests per day, recurrence of appointments, internal and external collaborates). Data may include, e.g., the total number of contacts, types of contacts involved in communications, frequency of communication with the contacts, and/or number of new contacts (e.g., per day). Data may include, e.g., information regarding the sophistication of the use of the communication and calendaring applications, or dependencies between these and/or other applications. Data may include, e.g., the total number of notes, the size of the notes, usage of notes, frequency of updates with respect to notes, and/or frequency of creation of new notes. Data may include, e.g., information on add-ons to the servers (e.g., compliance, archival, mobility, filtering).

Data may include, e.g., information related to client diversity (e.g., client revisions that have been connecting to the servers 110, client reliability). Data may include, e.g., information related to mobile diversity (e.g., uptime, downtime, and analysis of ActiveSync programs; uptime, downtime, cost, and analysis of Blackberry Enterprise Servers (BES)). Data may include, e.g., information related to Outlook Web Access and/or remote access.

Data may include, e.g., file types and information related to file editing, such as the frequency of edits, size of edits, duration of periods directed to editing, revisions, copies of revisions, users involved in the revisions, and/or users of revision histories. Data may include, e.g., information related to collaboration and/or content creation.

Data may include, e.g., the number of users for each application on the servers 110, the number of users added or removed over time from the servers 110, the amount of time (collectively or individually) spent for each application, the numbers of documents and/or other data created by the users, average user activity of the servers 110, or user dependency on the system encompassed by the servers 110, or any combination thereof

Data may indicate the third party applications installed on the infrastructure 112. The agent may discover applications by, for example, iterating the registries and/or file systems of servers 110 to search for the applications. The agent may identify applications from document types attached to communications sent by users of the infrastructure 112.

Data may indicate the reliability of the existing computing infrastructure 112. Examples of such data include the up-time of the infrastructure 112 (e.g., individual up-time of the servers 110, up-time of the overall infrastructure 112), up-time of applications on the infrastructure 112, event logs of the servers 110, information regarding past or present connectivity problems, patches, response times of servers 110, frequency and volume of scheduled maintenance sessions, network latency (e.g., latency experienced by a random sampling of users between their clients and servers 110), and/or network bandwidth. In some implementations, the agent may iterate servers 110 in the infrastructure 112 for such information. In some implementations, the agent may obtain availability events (e.g., start or stop events within the infrastructure 112, such as application freezes or system reboots) from an event log.

Data may indicate the cost of the infrastructure 112. Examples of such data include the hardware types, manufacturers, and acquisition dates for the application servers; hardware types, manufacturers, and acquisition dates for the client servers; support contracts for the application and client servers; frequency and volume of automation events on the application servers; and/or frequency and volume of administrative logins on the application servers.

Data may indicate the security policies of the infrastructure 112. Examples of such data may include account and password policy information such as the enforce password history, maximum password age, minimum password age, minimum password length, password complexity requirements, account lockout duration and/or account lockout threshold. Examples of data may include privilege levels of user logins across the servers 110 in the infrastructure 112. Examples of data may include kinds of traffic allowed to traverse the infrastructure 112, identities of ports available on resources in the infrastructure 112, and/or permissions for unidirectional and/or bidirectional traffic. Data may include, e.g., data collected from audits of the servers 110 (e.g., information about user logins and their associated privilege levels) to determine compliance with security policies. In some implementations, the agent may access domains directory services to obtain information.

In some implementations, the agent sorts the data about the computing infrastructure 115. For example, the agent may sort the data by bundling data according to users grouped according to their organizational units, the servers from which the data was retrieved, or any other basis. The agent may transmit the data to the migration system 115. The migration system 115 may store the collected data in a database on the computing infrastructure 112. The database may use file formats such as CSV or XML.

The migration system 115 may calculate metrics by analyzing the data from the computing infrastructure 112 (step 315). In some implementations, metrics may reflect usage of the computing infrastructure 112. The migration system 115 may aggregate data to determine the total number of users of the infrastructure 112, the number of users added and/or removed over predetermined periods of time, the number of communication mailboxes associated with each user, the number of mailboxes associated with groups of users, the sizes of mailboxes, and/or the rate of growth of storage needs over predetermined periods of time (e.g., over days, weeks, months). In some implementations, the migration system 115 may aggregate data according to users in organizational units. Thus, the migration system 115 may calculate metrics for each organizational unit as well as for the overall infrastructure 112.

In some implementations, metrics may reflect the reliability of the computing infrastructure 112. For example, the migration system 115 may calculate the up-time, down-time, and/or average time between failures for applications, services, or any other features of the infrastructure 112.

In some implementations, metrics may reflect the cost of the computing infrastructure 112. The migration system 115 may store information on expected costs associated with components, applications, and/or other aspects of a computing infrastructure 112. When the migration system 115 receives data from the agent, the migration system 115 may process the data according to stored information on costs to estimate the cost of the computing infrastructure 112. In some implementations, the migration system 115 may process the data to estimate costs of separate organizational units using the infrastructure 112.

For example, the migration system 115 may store cost estimates associated with hardware assets, peripheral devices, and/or storage based on acquisition cost, age, depreciation, licensing, maintenance, and/or support contracts, or other factors. The system 115 may store cost estimates for operating systems, operating system cluster configuration, and associated software, based on expected licenses such as client access licenses (CALs), support costs (e.g., software assurance), and/or maintenance costs (e.g., hours of labor). The system 115 may store operational cost estimates for patches based on their age and frequency of occurrence. The system 115 may store operation costs for power supplies based on expected costs to power and cool the supplies. The system 115 may store costs associated with third-party software based on costs for acquisition, licensing, and support (e.g., backup, compliance, archival, monitoring, management). The system 115 may store estimated charge-back costs associated with network traffic.

In some implementations, the migration system 115 may store cost estimates for third party applications. The estimates may include estimates when the applications are stored on the infrastructure 112 and when the applications are provided on alternative infrastructures 125. Different estimates may be provided for versions and/or variations of the applications that have different features.

In some implementations, the migration system 115 may store the cost estimates on a database. The migration system 115 may update the database based on updated cost estimates from third parties and/or information from users of the migration system 115. In some implementations, third parties update the database. In some implementations, the migration system 115 provides a generic cost estimate when the cost estimate for an aspect of a computing infrastructure 112 is unavailable. For example, the migration system 115 may provide a generic cost estimate for hardware when the database does not have an entry for identified hardware. In some implementations, the migration system 115 requests a cost estimate to users of the system 115.

The migration system 115 may store cost estimates for services on alternative computing infrastructures 125. The cost estimates may include different estimates for the services based on tiers of users, features, and/or sizing. The cost estimates may be normalized to be expressed on a per-user basis, or a per-user basis for different sizes of groups of users.

The migration system 115 may evaluating the metrics of the computing infrastructure 112 against metrics for a plurality of alternative computing infrastructures 125 (step 320). In some implementations, the migration system 115 may evaluate the applications of the infrastructure 112 against the applications available on the alternatives 125, including features of applications on either infrastructure 112, 125. The migration system 115 may evaluate the storage capacity of the infrastructure 112 against that of the alternatives 125.

The migration system 115 may compare the costs of the computing infrastructure 112 against costs for alternative computing infrastructures 125. The system 115 may compare costs based on applications, services, or other features of the computing infrastructure 112. The system 115 may compare costs of the infrastructures 112, 125 on a per-feature basis. In some implementations, the system 115 may compare costs of an organization unit on the computing infrastructure 112 against costs of the organization unit as supported on alternative infrastructures 125.

The migration system 115 may evaluate the security requirements of the computing infrastructure 112 against the security capabilities of the alternative computing infrastructures 125. The security capabilities of the alternative 125 may be stored in a system table. The security capabilities may include account and/or password policies. The security capabilities may include the security of data centers associated with the alternatives 125.

Based on the comparisons, the migration system 115 may select an alternative computing infrastructure 125 to replace the evaluated computing infrastructure 112 (step 325). In some implementations, the system 115 may select a plurality of alternatives 125. The system 115 may rank the alternatives 125 as recommendations for the administrator.

The alternative infrastructure 125 may replace a portion of the evaluated infrastructure 112. The migration system 115 may select the alternative 125 based on alternative infrastructures 125 used by organizations of comparable size and industry. In some implementations, the migration system 115 may calculate estimates of time for migrating to the selected alternative 125 and/or reverse migrating (also referred to herein as “rolling back”) from the alternative infrastructure 125 to the original infrastructure 112. The estimates may be based on network bandwidth and/or latency of the existing infrastructure 112 and/or size of the infrastructure 112.

In some implementations, the migration system 115 may generate a report with an analysis of the data from the computing infrastructure 112 and the selected alternative infrastructure 125 (step 330). The report may identify applications, services, or other features to migrate to the alternative infrastructure 125. The report may include the calculated cost of ownership of the infrastructure 112 (e.g., costs associated with the applications, services, or other features) and the estimated cost of the selected alternative 125. The report may include visualizations of the uptime percentages of applications on the infrastructure 112, types of errors, numbers of users per application, document types used by users, percentages of internal and external contacts, any combination thereof, or any other data relevant to analysis of a computing infrastructure. The report may describe the expected ease of migration. The report may include recommendations for users for initial migration to the alternative 125, described in more detail below. The report may include estimates of time for migrating or reverse migrating the users between the infrastructures 112, 125.

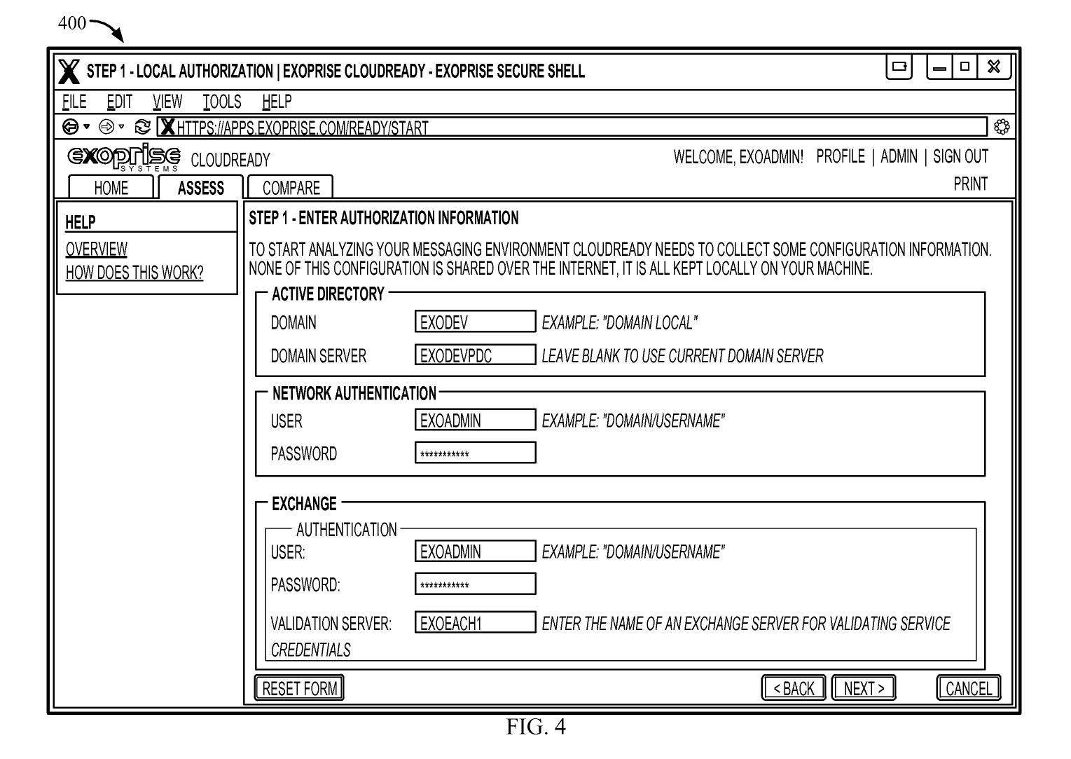

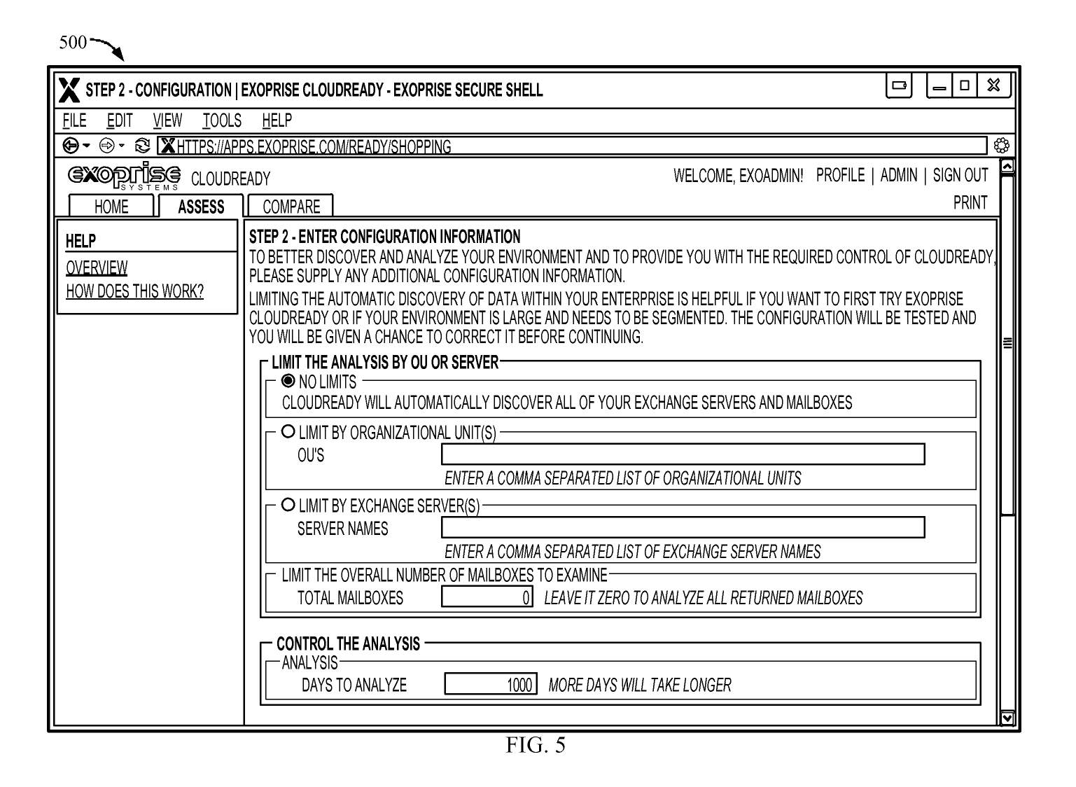

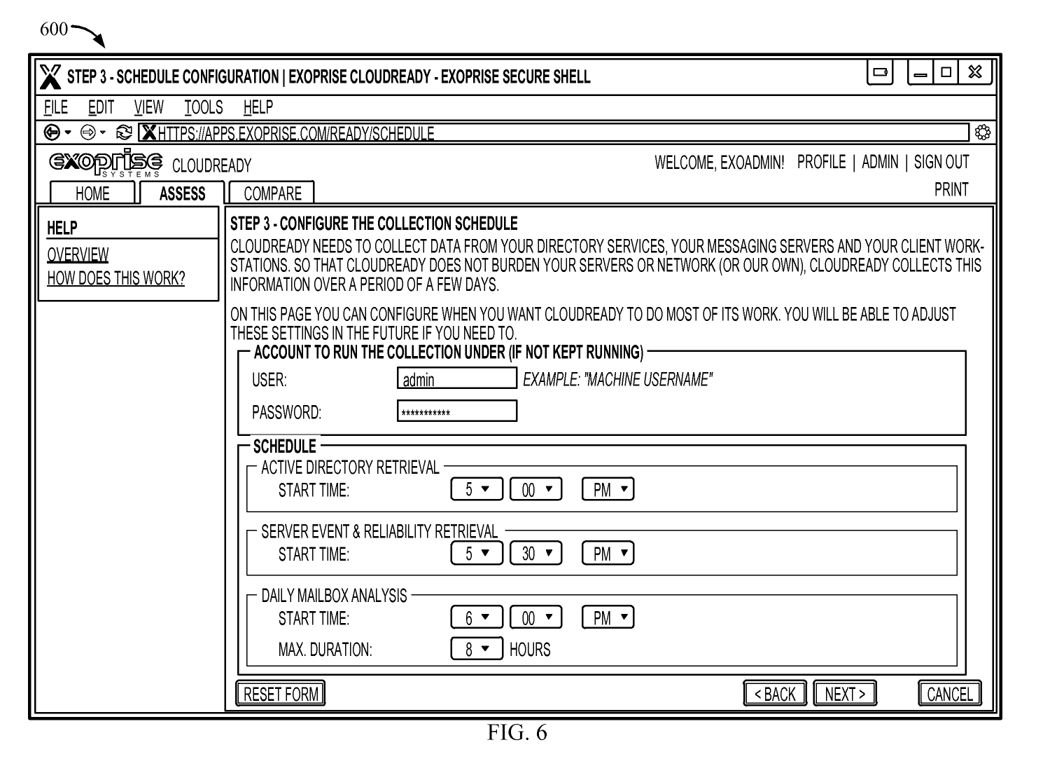

Referring now to FIGS. 4-8, exemplary user interfaces displayed by an agent that obtains data about a computing infrastructure 112 are shown and described. FIG. 4 is an exemplary user interface 400 that accepts credentials from an administrator of the computing infrastructure and the identification of an active directory. FIG. 5 is an exemplary user interface 500 from which an administrator may configure the scope of the agent's discovery of the computing infrastructure 112. The administrator may limit the agent's scope by organization unit, servers, and/or overall number of mailboxes to examine. The administrator may limit the period of time during which the agent may access the computing infrastructure 112 for discovery. FIG. 6 is an exemplary user interface 600 from which an administrator may configure the agent's discovery schedule. The administrator may configure the times when the agent may retrieve data from an active directory, retrieve event and reliability information from servers, and/or analyses mailboxes.

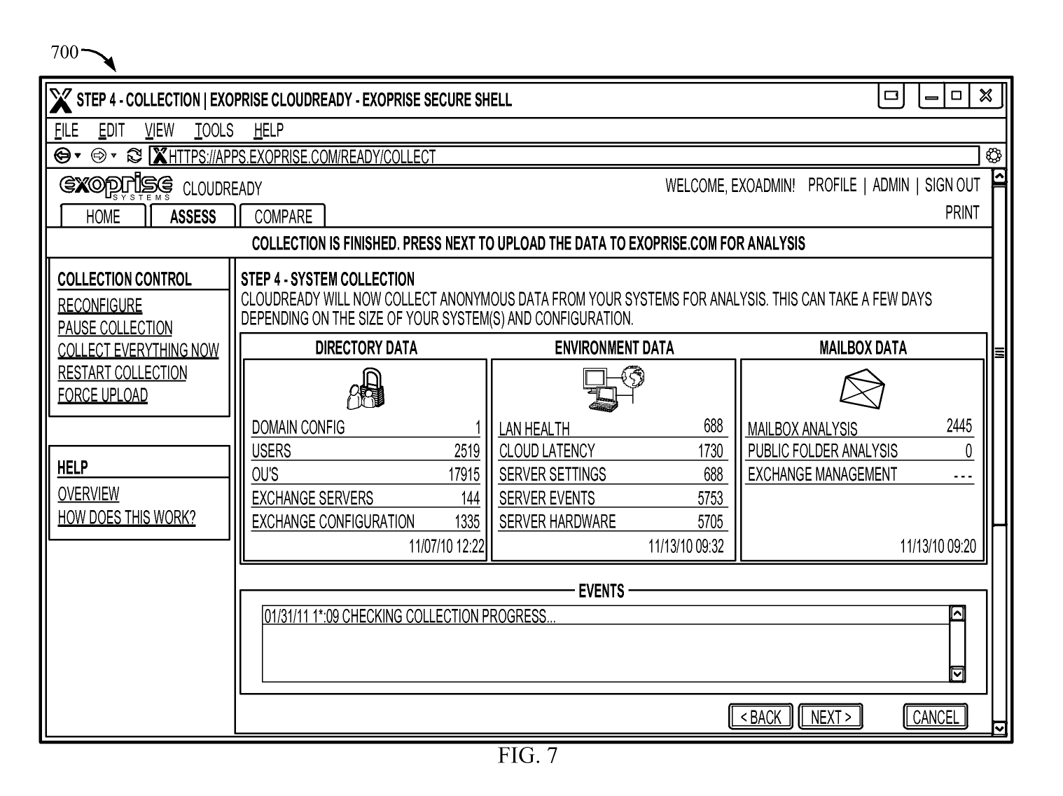

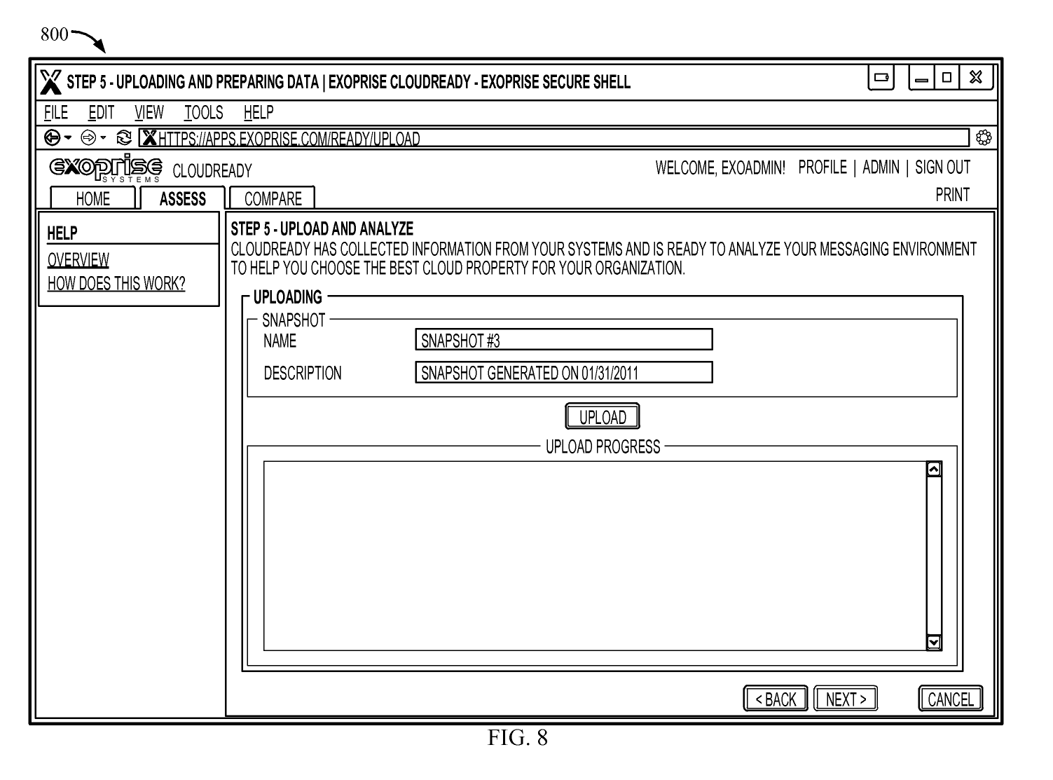

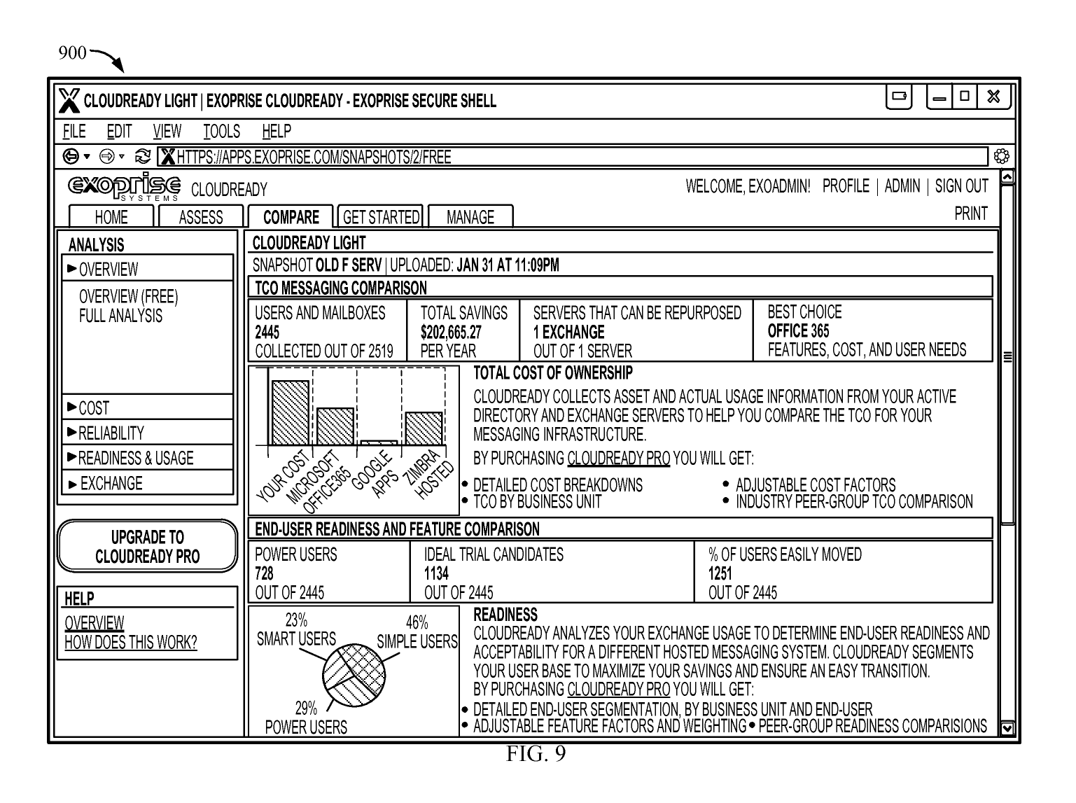

FIG. 7 is an exemplary user interface 700 that displays the scope of the agent's discovery. The interface 700 may display an overview of the computing infrastructure 112 from the directory, environment, and mailbox perspectives. Regarding the directories, the interface 700 may display the number of users, organizational units, exchange servers, and exchange configurations in the computing infrastructure 112 for which the agent may obtain data. Regarding the environment, the interface 700 may display aspects of the infrastructure 112 for which the agent may obtain data, such as the local area network (LAN) health, network latency, server settings, server events, and serve hardware. The interface 700 may display the number of mailboxes in the infrastructure 112 for which the agent may obtain data.

FIG. 8 is an exemplary user interface 800 that alerts an administrator that discovery of the data regarding the computing infrastructure 112 has been completed. The interface 700 allows the administrator to transmit the collected data to the migration system 115 by, for example, uploading the data.

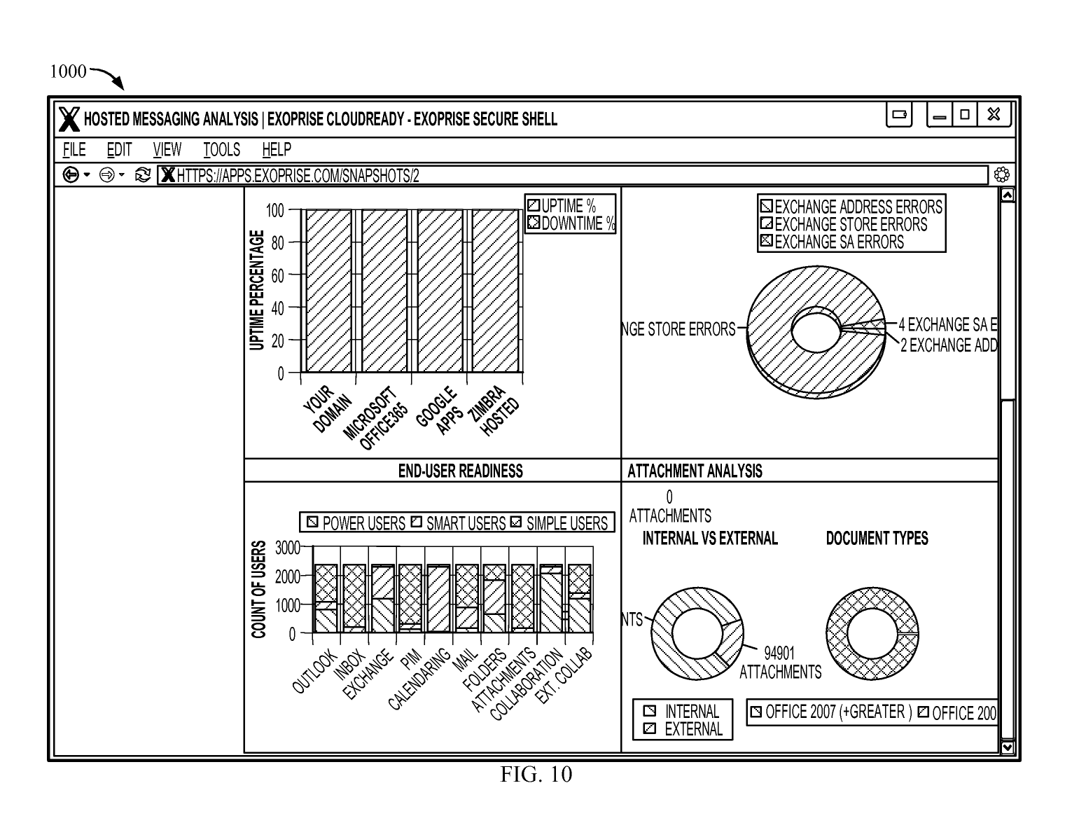

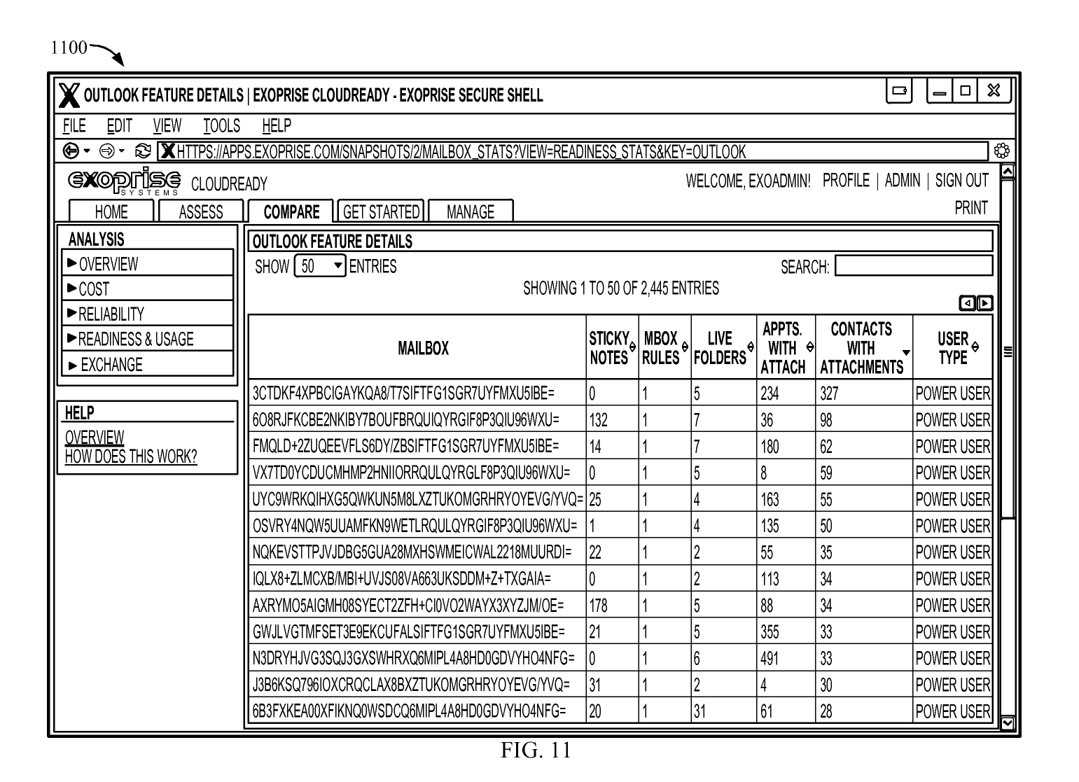

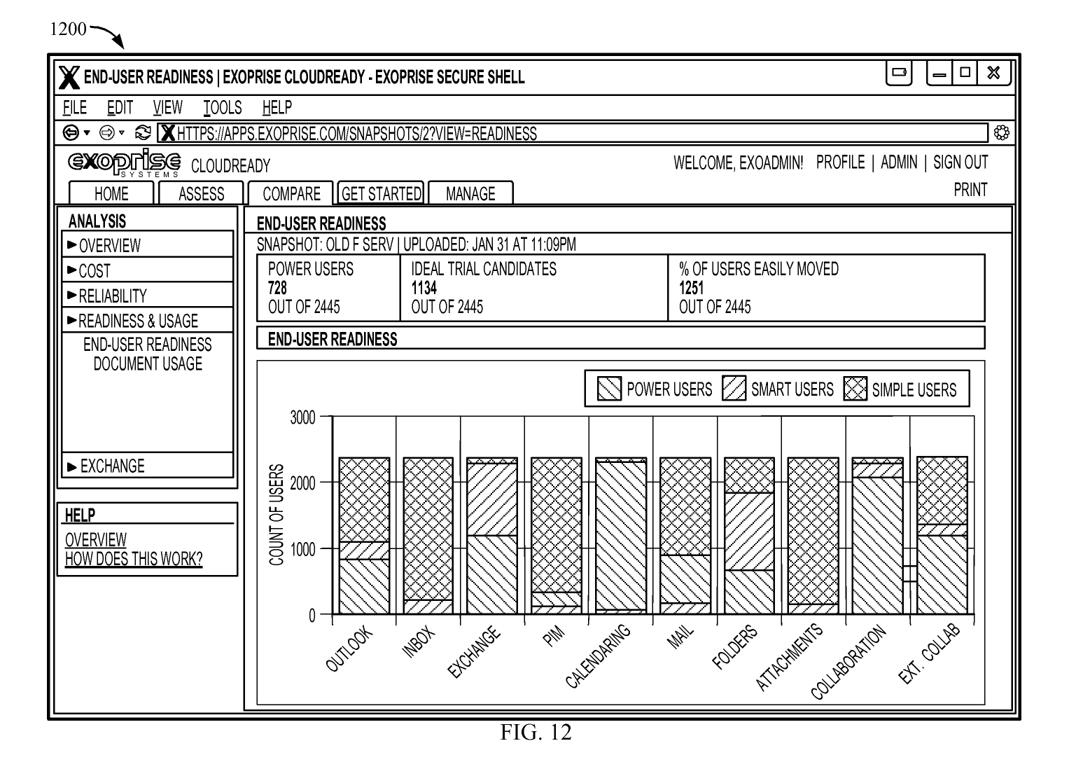

Referring now to FIGS. 9-12, exemplary user interfaces associated with a report on the computing infrastructure and alternative are shown and described. FIG. 9 is an exemplary user interface 900 that displays the cost of ownership for the infrastructure 112 and the tiers of users. FIG. 10 is an exemplary user interface 1000 that displays metrics from the analysis of the computing infrastructure 112. FIG. 11 is an exemplary user interface 1100 that displays information about mailboxes on an e-mail server 110 in the infrastructure 112. FIG. 12 is an exemplary user interface 1200 that displays the tiers of users and metrics associated with the users of the infrastructure 112.

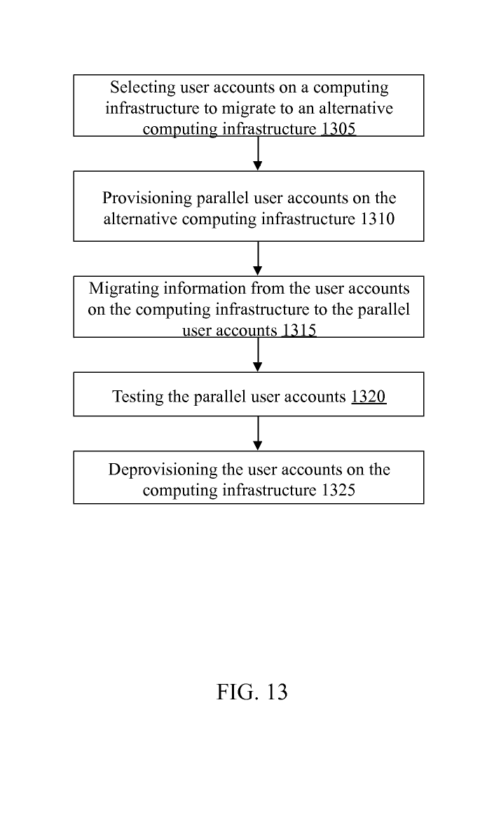

Referring now to FIG. 13, a flow diagram for an exemplary method of migrating users from a computing infrastructure to an alternative computing infrastructure and testing the success of the migration is shown and described. Although the steps are described in reference to the system of FIG. 1, the steps may be performed by other components capable of exercising the same or similar functionality. Although the steps are described in an order, in some implementations, the steps may be performed in other orders.

The migration system 115 may select user accounts on a computing infrastructure 112 to migrate to an alternative computing infrastructure 125 (step 1305). The system 115 may evaluate user activity on the infrastructure 112 to calculate metrics for identifying candidates for initial migration. The migration system 115 may base the calculations on data on each user's use of services and/or applications. In some implementations, exemplary data may include the user's last logon, logon frequency, logon type, access type, mobile phone access type and/or location, size of the user's store associated with the service or application, growth of the store over a predetermined period of time (e.g., days, weeks, months), folders, folder depth, folder types, and/or user-configured processing rules. Some exemplary data may include information on delegation of access, store items, store item types, distributions of store items in folders, unread items, new items over a predetermined period of time, calendar use (e.g., calendar items per day, calendar item types), mail store item type, rate and frequency of mail store item type creation, number of items forwarded, and/or number of items replied to. In some implementations, data may include flags associated with items marked according to importance, confidentiality, and/or priority. Data may include, e.g., information relating to attachments (e.g., use, type, size, frequency, access, and modification). Data may relate to recipients. Data may relate to item affinity, frequency, and periodicity.

The system 115 may store information relating metrics to tiers of users. For example, the system 115 may store a table with metrics defining users as “simple,” “smart,” or “power” users of the infrastructure 112. The tiers may indicate the user sophistication with respect to the computing infrastructure 112. In some implementations, the tiers may indicate the order in which users may be migrated to the alternative 125 (e.g., “power” users migrated first, followed by “smart” users). The migration system 115 may compare metrics for each user against metrics in the table to assign a tier to the user. The migration system 115 may record the users belonging to each tier.

In some implementations, the migration system 115 may adjust the tier of some users based on their interactions with other users. For example, one user may be assigned to the “smart” user tier based on metrics, but the user may interact frequently with “power” users. The migration system 115 may move the user into the “power” user tier such that users who interact with one another may be migrated to the alternative infrastructure 125 at the same time. In some implementations, the migration system 115 may adjust the tier based on the user's organizational unit (e.g., research and development, marketing, sales). For example, 95% of the users in the marketing unit may be assigned to the “smart” user tier. The remaining users, regardless of their initially assigned tier, may be re-assigned to the “smart” user tier. Thus, users in the same organizational units may be migrated to alternative infrastructure 125 together.

The migration system 115 selects the users in a tier for migration to the alternative computing infrastructure 125. In some implementations, the migration system 115 may invite the selected users to participate in the migration via, for example, electronic communication. The electronic communication may request users to create credentials (e.g., username, password) for their accounts on the alternative infrastructure 125. When the migration system 115 receives a user's acceptance of the invitation to participate and the user's credentials, the migration system 115 may enter the user into a list of users to migrate. The migration system 115 may deliver a migration and adoption tool to the user's client 105. The client 105 may execute the migration and adoption tool that operates with the migration system 115 to migrate the user account to the alternative computing infrastructure 125.

In some implementations, the migration system 115 begins migration when a threshold number and/or percentage of invited users accept the invitations. In some implementations, the migration system 115 begins migration after a predetermined lapse of time after sending the invitations, regardless of the number of responses.

The migration system 115 may select a time to begin migration, which may be communicated to the users to be migrated. The migration system 115 may provision user accounts on the alternative computing infrastructure 125 (step 1310). The user accounts may parallel the users' accounts on the existing infrastructure 112. The migration system 115 may allocate storage space for each parallel account. The migration system 115 may configure each user account according configuration information obtained from user accounts on the existing infrastructure 112. The migration system 115 may migrate documents, electronic communications, files, and/or any other type of information associated with a user account on the existing infrastructure 112 to the user's parallel account on the alternative infrastructure 125 (step 1315).

The migration system 115 may test the parallel user accounts during migration (step 1320). The migration system 115 may calculate metrics from the original infrastructure 112 to compare against metrics of the alternative infrastructure 125. For example, the migration system 115 may measure a delivery time for an electronic communication transmitted between user accounts on the original infrastructure 112. The measurement may be an estimate of a standard delivery time for electronic communications. The estimate may be compared against delivery times between user accounts on the alternative computing infrastructure 125.

In some implementations, tests may involve synthetic transactions. For example, the migration system 115 may transmit a test electronic communication to an account on the alternative infrastructure 125. The migration system 115 may access the account and verify the electronic communication arrived. In another example, the migration system 115 may transmit an electronic communication from a user account on the existing infrastructure 112 to a parallel user account. The migration system 115 may measure a time between the transmission of the communication and the receipt thereof. In some implementations, if the time exceeds a predetermined period of time, the migration system 115 may record the test result as a timeout. The migration system 115 may send notifications (e.g., an event log) to support staff regarding the timeout. In some implementations, the migration system 115 may initiate additional tests to determine the cause of the timeout. The migration system 115 may initiate similar tests for other applications, such as chat applications and voice messaging services.

In some implementations, the migration system 115 may simulate a login into a parallel user account and user activity within the account. The system 115 may record the periods of times needed to accomplish the user activities. The system 115 may track the success and/or failure rates of user activities. In some implementations, the migration system 115 may use Internet Control Message Protocol (ICMP) packets to determine the responsiveness of the alternative infrastructure 125. The system 115 may track the success, failure, and/or response times for tests involving the packets.

From such verifications, measurements, or any other metrics, the migration system 115 may monitor the functionality of the parallel user accounts. From such verifications, measurements, or any other metrics, the migration system 115 may monitor the service availability, service latency, network latency, and bandwidth utilization of the alternative infrastructure 125 as users are migrated onto the alternative 125.

In some implementations, the migration system 115 may suspend migration of user accounts based on test results (e.g., network latency, network bandwidth). For example, if test results show that network latency for the alternative infrastructure 125 exceeds the latency for the existing infrastructure 112 by a predetermined threshold, the migration system 115 may suspend further migration. The migration system 115 may send the administrator a communication comparing the network latencies. The communication may inform the administrator that migration has been suspended due to the test results. The communication may request permission from the administrator to continue migration. Thus, if an administrator considers the alternative infrastructure's 125 performance insufficient compared to the existing infrastructure's 112, an administrator may decide whether to proceed with migration.

In some implementations, if the administrator grants permission, the migration system 115 may resume migration to the parallel user accounts. If the administrator denies permission, in some implementations, the administrator may instruct the migration system 115 to continue monitoring the alternative infrastructure 125. Users may continue using the original and alternative infrastructures 112, 125 as the migration system 115 monitors the alternative 125 to evaluate its performance. The migration system 115 may continue communicating metrics about the alternative infrastructure's 125 performance to the administrator. If the administrator considers the performance consistent and/or acceptable, the administrator may send an instruction to the migration system 115 to resume migrating user accounts to the alternative infrastructure 125.

In some implementations, denying permission results in reverse migration of at least a portion of the parallel user accounts to accounts on the existing infrastructure 112. The administrator may select the parallel user accounts to reverse migrate (e.g., accounts for an organizational unit, accounts associated with the “smart” user tier). The administrator may select a time for the reverse migration to begin. The migration system 115 may transfer information from the parallel user accounts back to the original accounts. In some implementations, the migration system 115 may deprovision the parallel user accounts after completing the reverse migration to the original infrastructure 112.

In some implementations, the migration and adoption tool on the user's client 105 may communicate with the migration system 115 to deliver training tailored to the user. For example, the migration system 115 may transmit training programs for use of the alternative infrastructure 125 to the adoption tool. The migration system 115 may transmit training programs according to the tier the user belongs in (e.g., “simple,” “smart,” “power”). The user may execute the training programs to learn how to use the alternative infrastructure 125. In some implementations, the adoption tool transmits information about the user's progress through the training programs to the migration system 115.

The migration system 115 may deprovision user accounts on the existing computing infrastructure 112 after migration to the parallel user accounts (step 1325). In some implementations, the migration system 115 may deprovision a user account after determining that the user has not logged into the user account for a predetermined period of time (e.g., the user is using the parallel user account). The migration system 115 may deprovision a user account after at least a portion of the alternative infrastructure 125 has been tested to the satisfaction of the administrator. For example, the system 115 may deprovision an account if the applications the user uses have been tested on the alternative infrastructure 125.

In some implementations, as the migration system deprovisions accounts, the system 115 may continue to evaluate the resources on the existing infrastructure 112. The migration system 115 may evaluate the number of users migrated to the alternative infrastructure 125 and/or the reduced use of resources on the existing infrastructure 125 due to the migration. In some implementations, the migration system 115 may make recommendations to the administrator to re-purpose and/or decommission resources of the infrastructure 112.

For example, the migration system 115 may determine for one e-mail server, 92% of the user accounts stored therein have been migrated to the alternative infrastructure 125 and the server is idle 97% of the time. The migration system 115 may determine that for another e-mail server, only 25% of the user accounts stored therein have been migrated, and the server is idle 67% of the time. The migration system 115 may send an electronic communication to the administrator recommending that user accounts on the first e-mail server be migrated to the second e-mail server and that the first e-mail server be decommissioned or purposed as an applications server, by way of example.

After migration has been completed, the migration system 115 may continue testing the parallel user accounts. In some implementations, the migration system 115 may monitor login activity for user accounts on the existing and alternative infrastructures 112, 125. Thus, the migration system 115 may determine if users are using accounts on the alternative infrastructure 125. The migration system 115 may monitor user activity (e.g., number of documents generated, number of e-mails sent or received, number of documents shared via e-mail) on the alternative infrastructure 125 and compare metrics of such activity against metrics for user activity on the original infrastructure 112. The migration system 115 may generate a report comparing user activity on the infrastructures 112, 125. From the report, an administrator may determine the success of using the alternative infrastructure 125.

In some implementations, the migration system 115 may continue testing to evaluate the performance of the alternative infrastructure 125. The tests may detect service unavailability, network bandwidth, network latency, or any other metric. In some implementations, the migration system 115 may perform tests to detect changes in the configurations of services and/or applications on the alternative infrastructure 125. For example, the system 115 may perform tests to determine that the configurations of data centers in the alternative infrastructure 125 have changed. In some implementations, the migration system 115 may monitor requests and responses for web-based applications and services to detect upgrades to the applications and services.

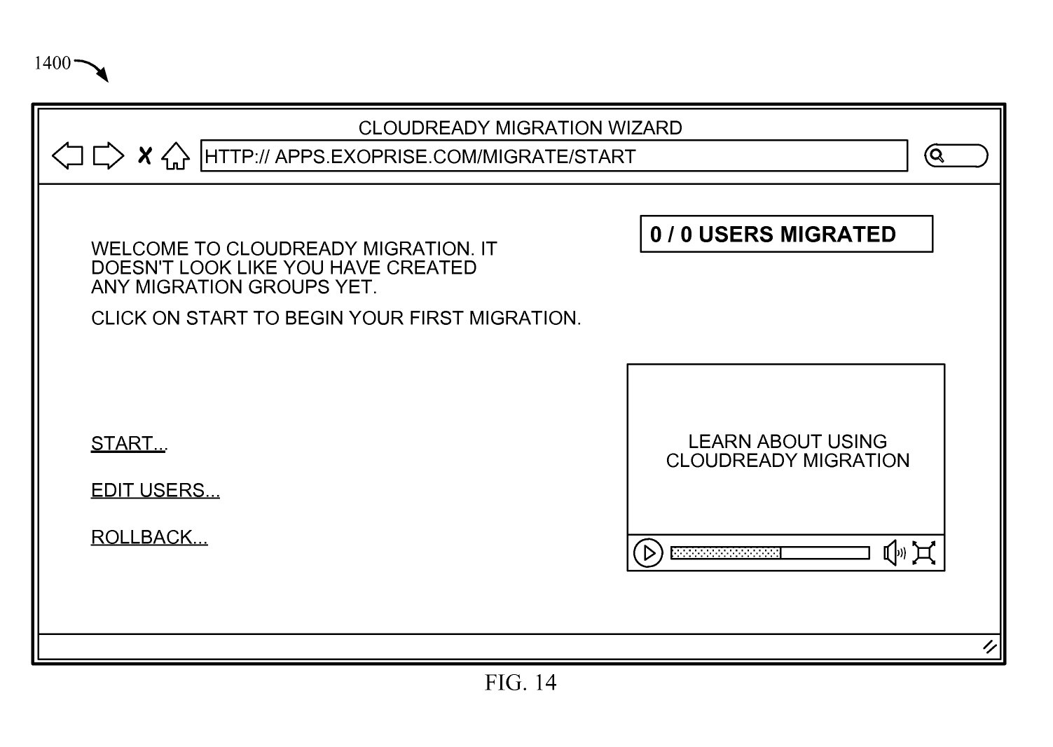

Referring now to FIGS. 14-24, exemplary user interfaces for configuring a migration, used in tandem with the method of FIG. 13, are shown and described.

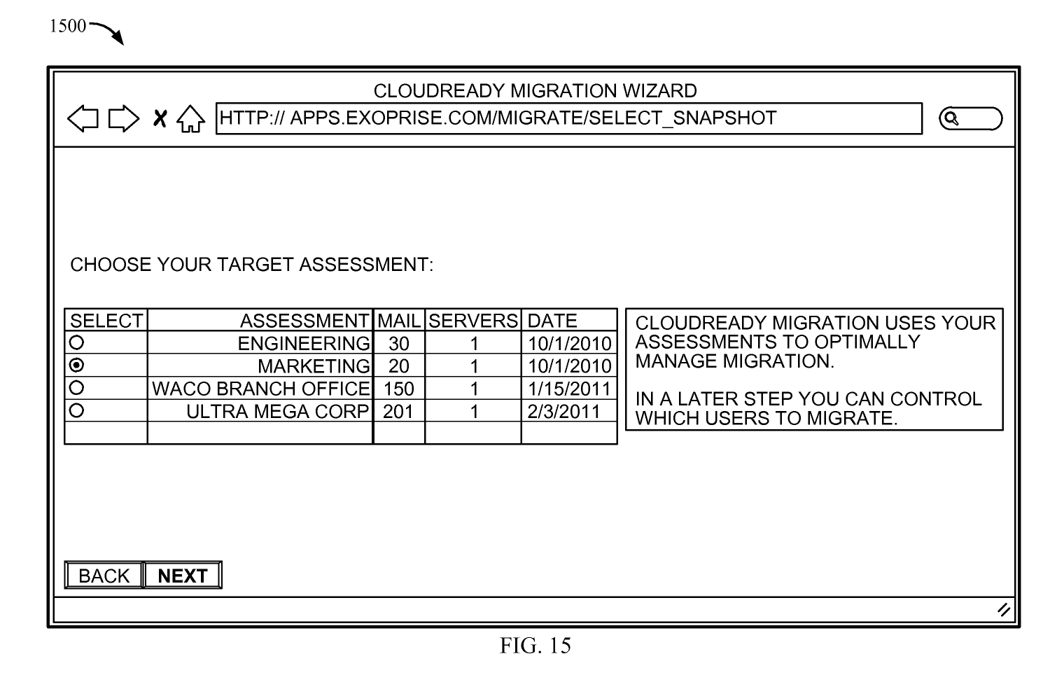

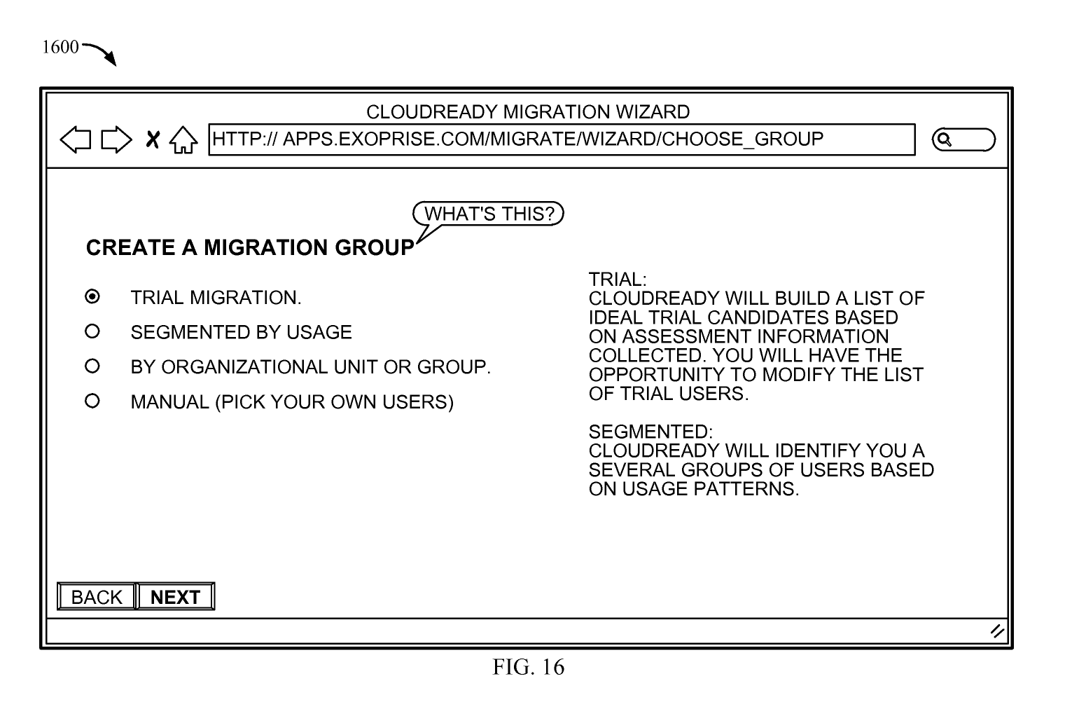

FIG. 14 is an exemplary user interface 1400 from which an administrator of the computing infrastructure 112 may initiate a migration, manually set users as migrated or not migrated (e.g., “edit users”), or roll back a migration. FIG. 15 is an exemplary user interface 1500 from which an administrator may select an assessment corresponding to a portion of the computing infrastructure 112 to be migrated. FIG. 16 is an exemplary user interface 1600 from which an administrator may select users to migrate. Based on this interface 1600, an administrator may select users the migration system 115 has selected for a trial migration, users based on their tier, users based on their organizational unit, or users to be selected manually by the administrator.

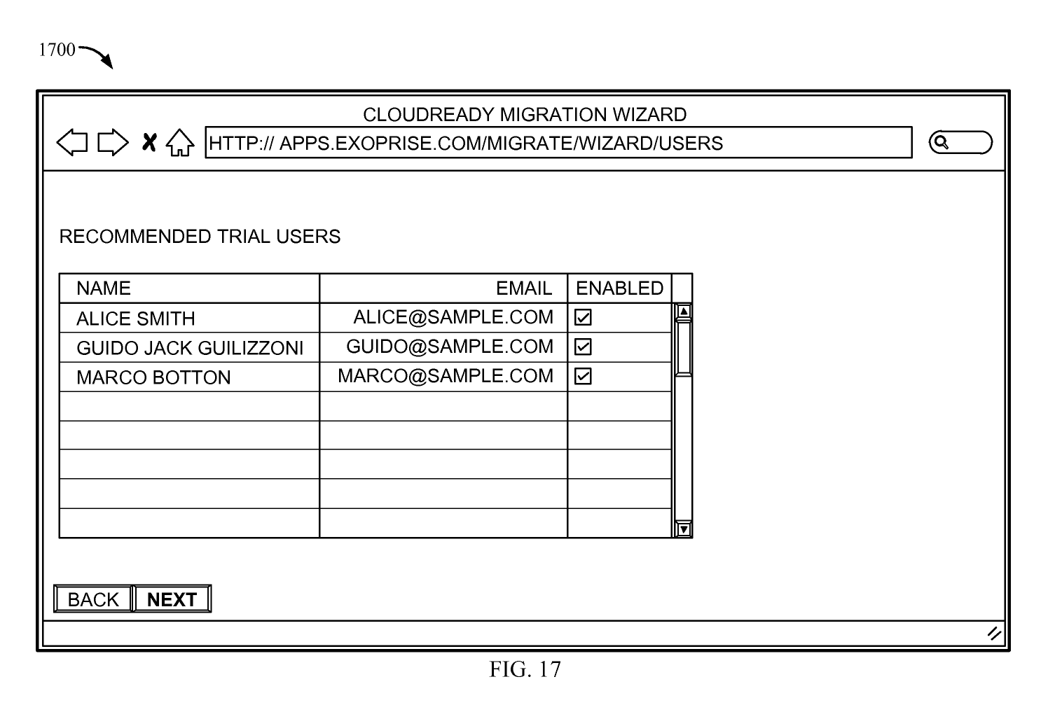

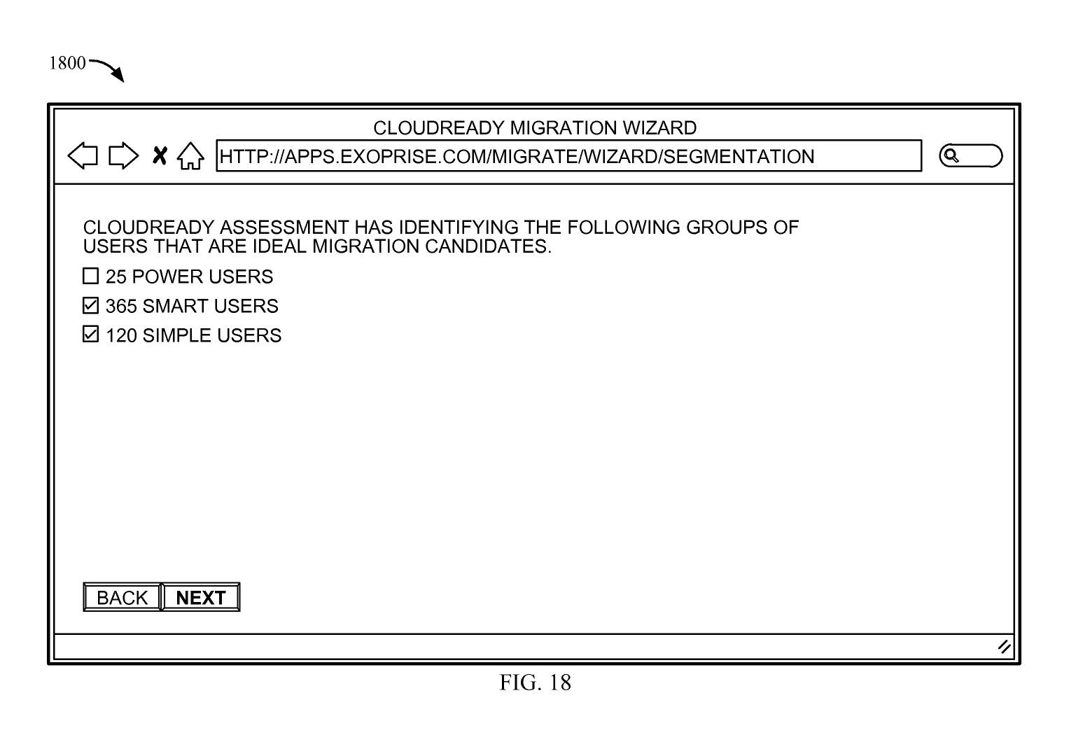

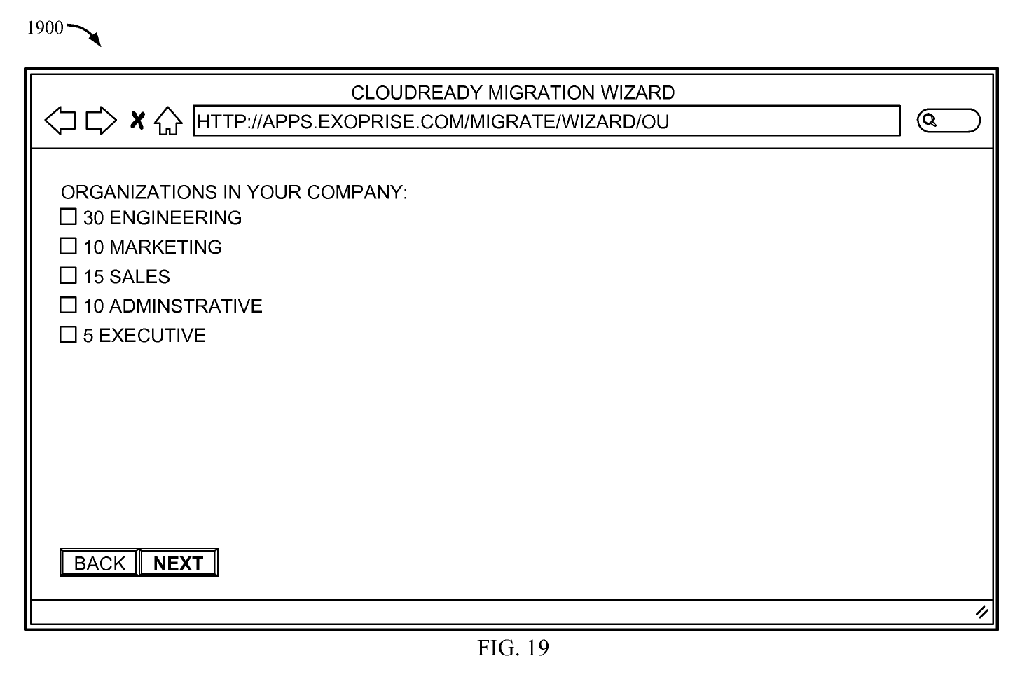

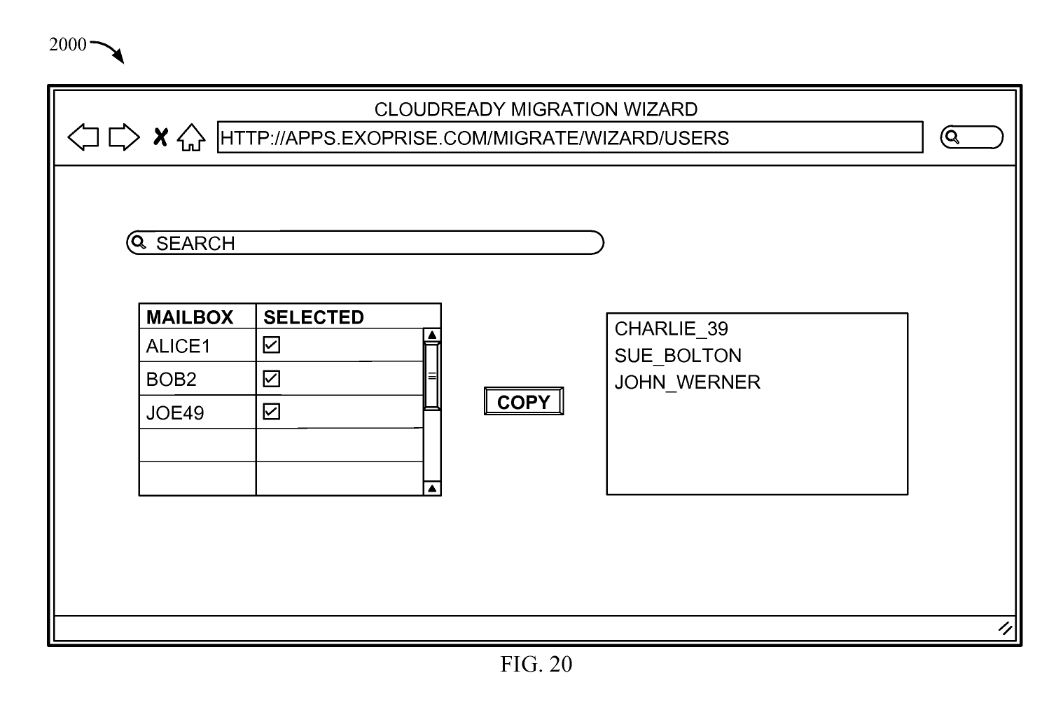

FIG. 17 is an exemplary user interface 1700 displaying users the migration system 115 has recommended as trial users for migration. FIG. 18 is an exemplary user interface 1800 displaying tiers into which the users have been segmented. The administrator may select users in one or more tiers for migration. FIG. 19 is an exemplary user interface 1900 displaying tiers organizational units. The administrator may select users in one or more organizational units for migration. FIG. 20 is an exemplary user interface 2000 displaying a list of users. The administrator may select users from the list for migration.

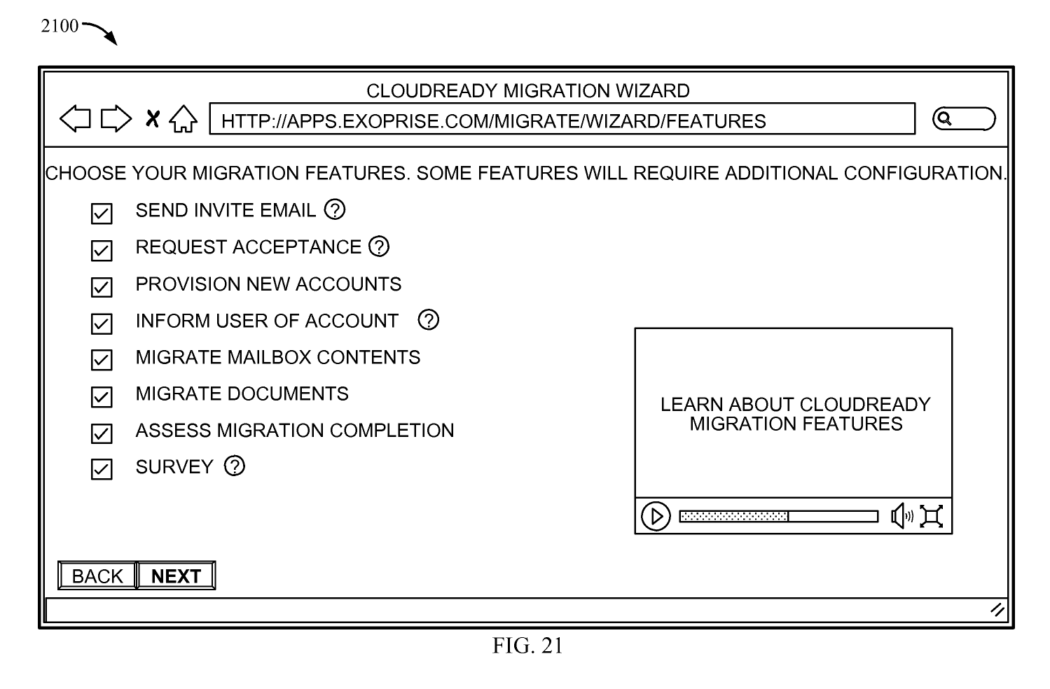

FIG. 21 is an exemplary user interface 2100 displaying features an administrator may select for the migration. Based on selected features, the migration system 115 may send e-mail invitations to users to participate in the migration. The invitations may request the users' acceptance to participate in the migration. The migration system 115 may provision parallel user accounts for the users. The migration system 115 may inform the users via e-mail, by way of example, that their accounts have been created. The migration system 115 may request user credentials (e.g., username, password) from the users for the parallel accounts. The migration system 115 may migrate the contents of the users' electronic mailboxes to their parallel accounts. The migration system 115 may migrate documents of the users' accounts to their parallel accounts. The migration system 115 may apprise the administrator of the progress and/or completion of the migration. The migration system 115 may send users surveys with questions regarding the migration.

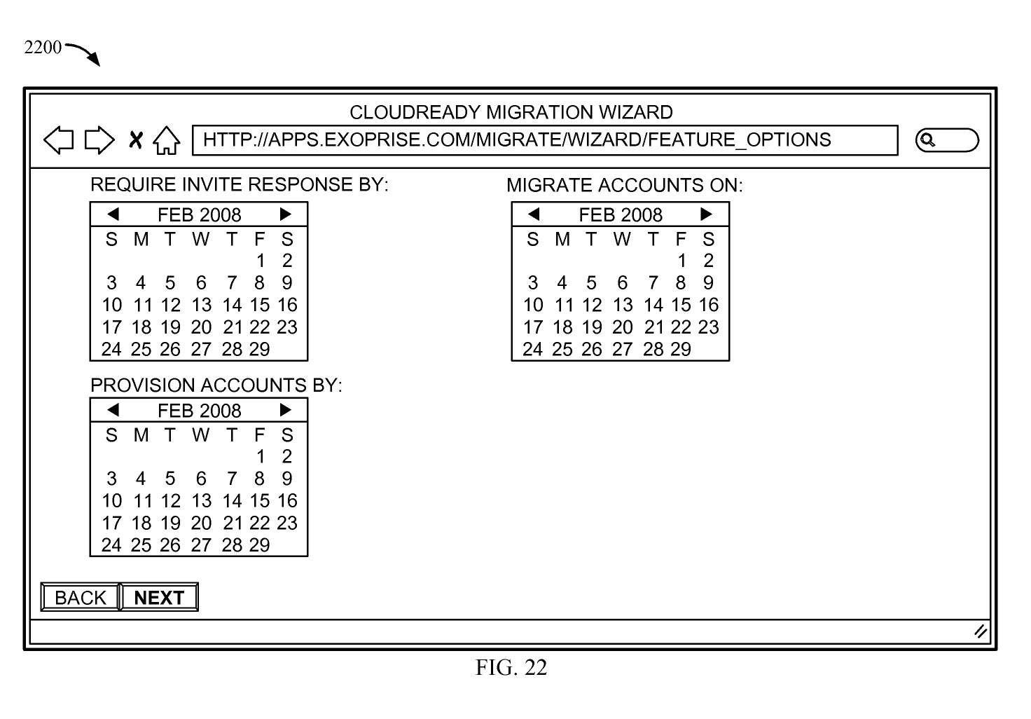

FIG. 22 is an exemplary user interface 2200 enabling an administrator to select time periods for the migration. From the interface 2200, the administrator may select deadlines for receiving responses to invitations to participate in migration, provisioning accounts, and/or migrating accounts to the alternative computing infrastructure 125.

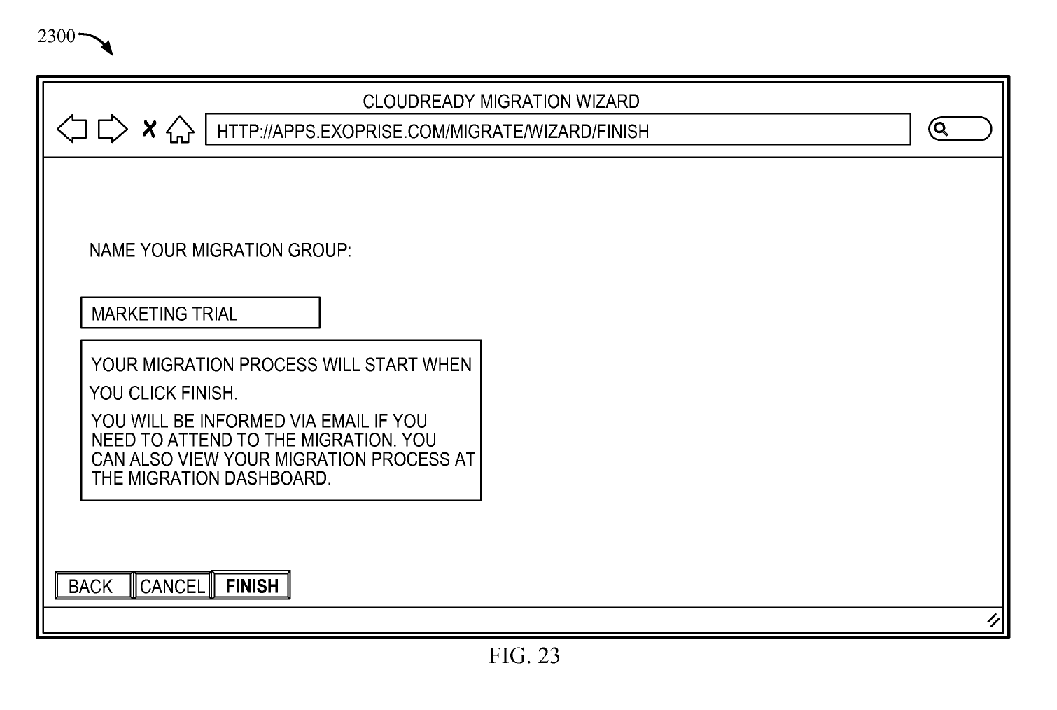

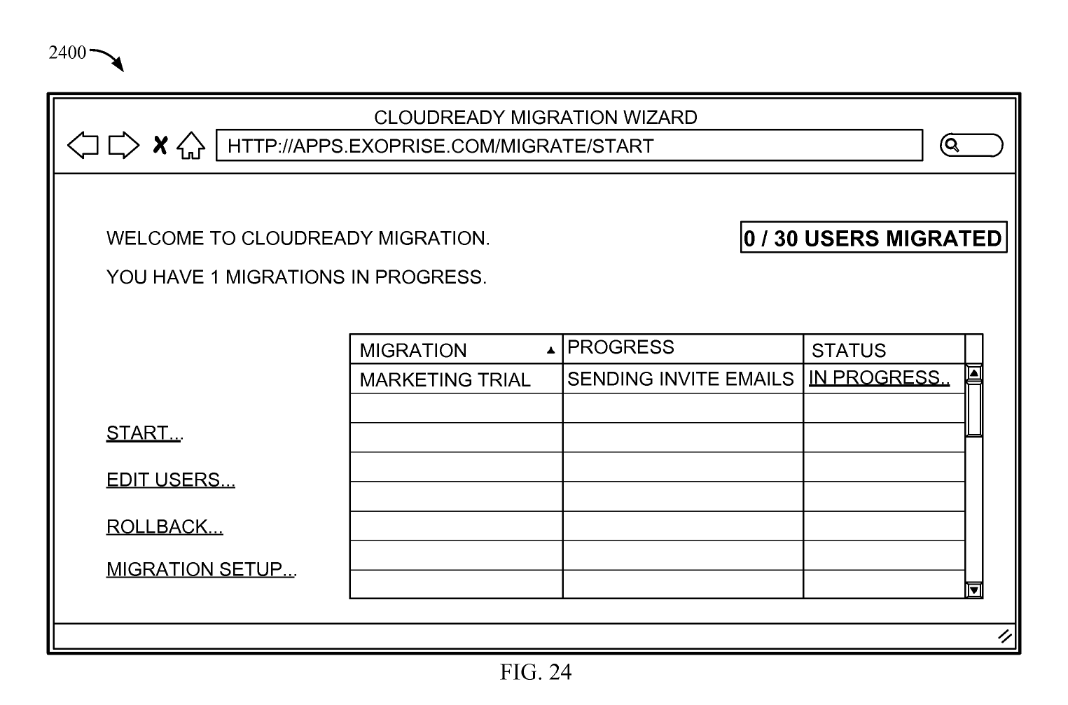

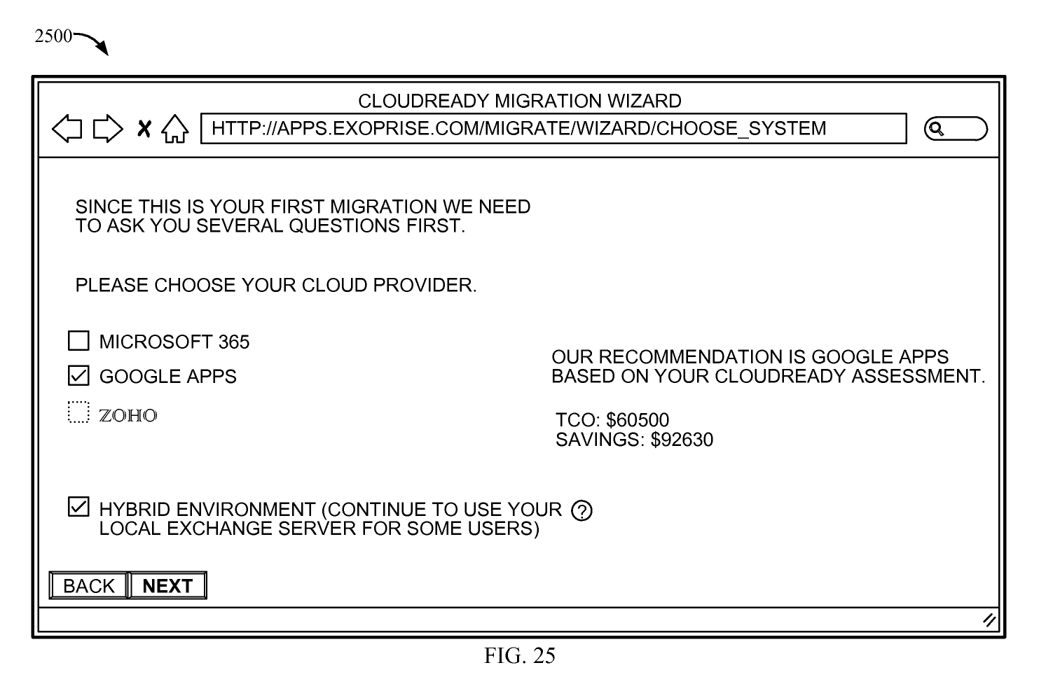

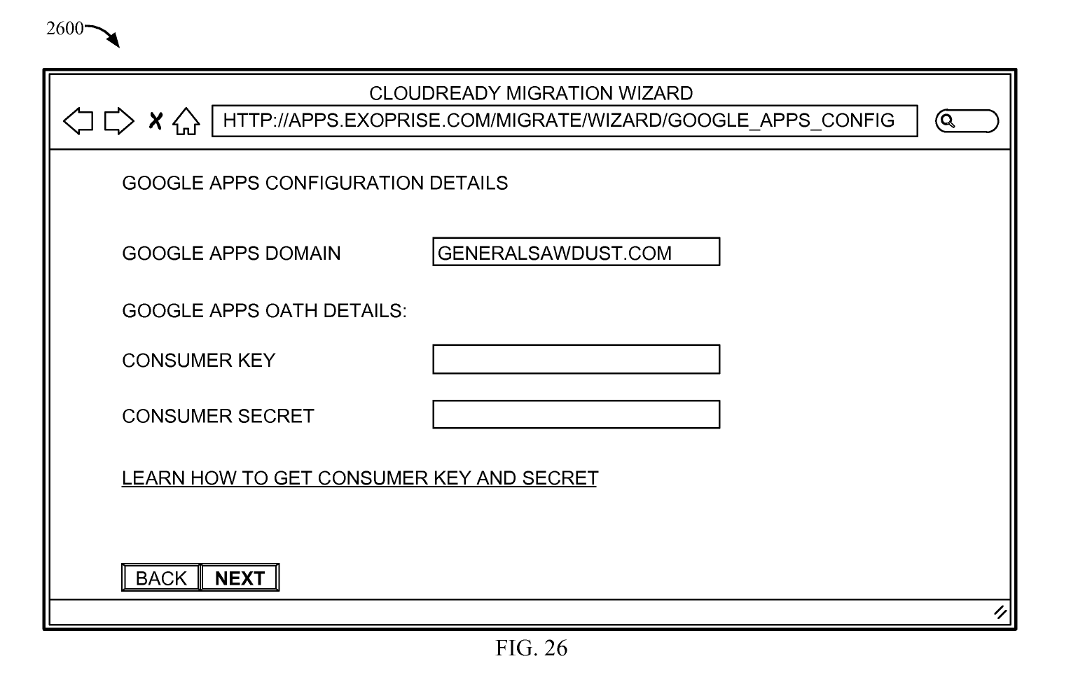

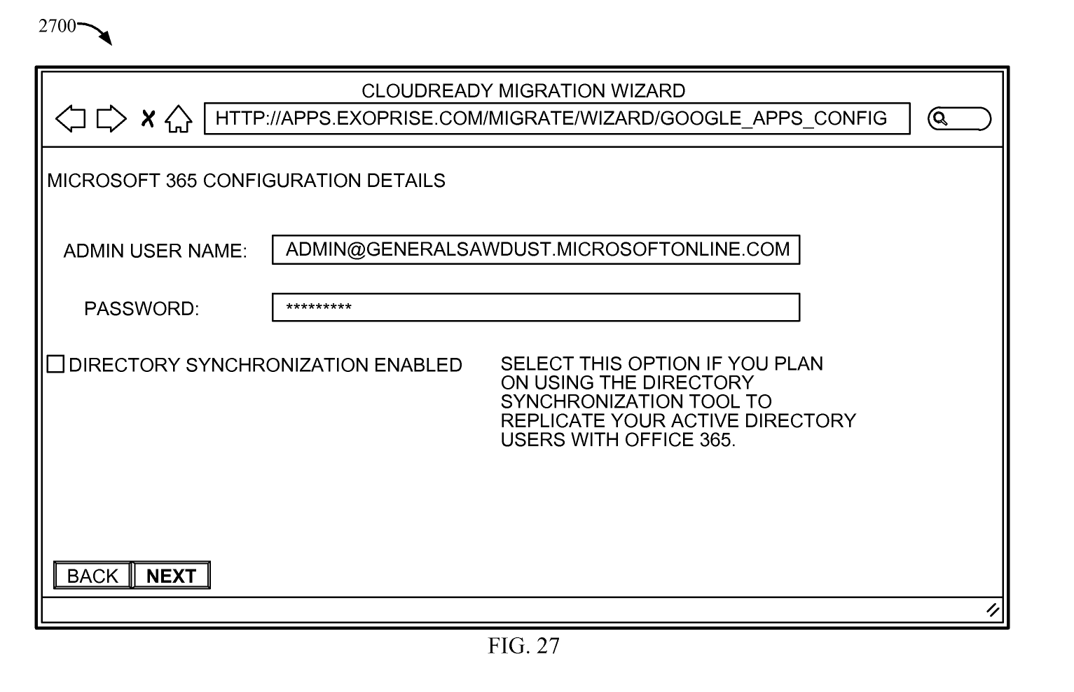

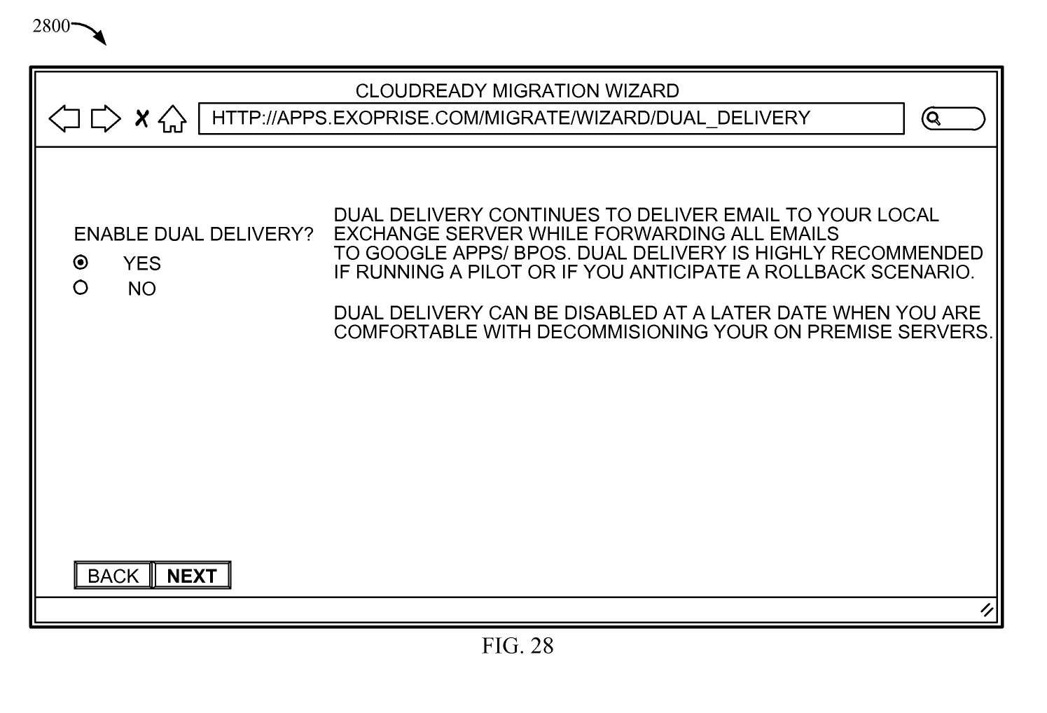

FIG. 23 is an exemplary user interface 2300 from which the administrator may initiate a migration. Once the administrator initiates the migration, the migration system 115 may display the exemplary user interface 2400 of FIG. 24, which displays information about the migration being in progress.

Referring now to FIGS. 25-28, exemplary user interfaces for configuring a migration, used in tandem with the method of FIG. 13, are shown and described. FIG. 25 is an exemplary user interface 2500 from which the administrator may select the alternative computing infrastructure 125 (e.g., a target cloud provider). FIGS. 26-28 are exemplary user interfaces 2600. 2700, 2800 from which the administrator may configure the alternative computing infrastructure 125, according to the provider of the infrastructure 125. From the exemplary user interface 2800 of FIG. 28, an administrator may specify that messages for users be delivered to user accounts on both the original computing infrastructure 112 and the alternative 125, as applicable.

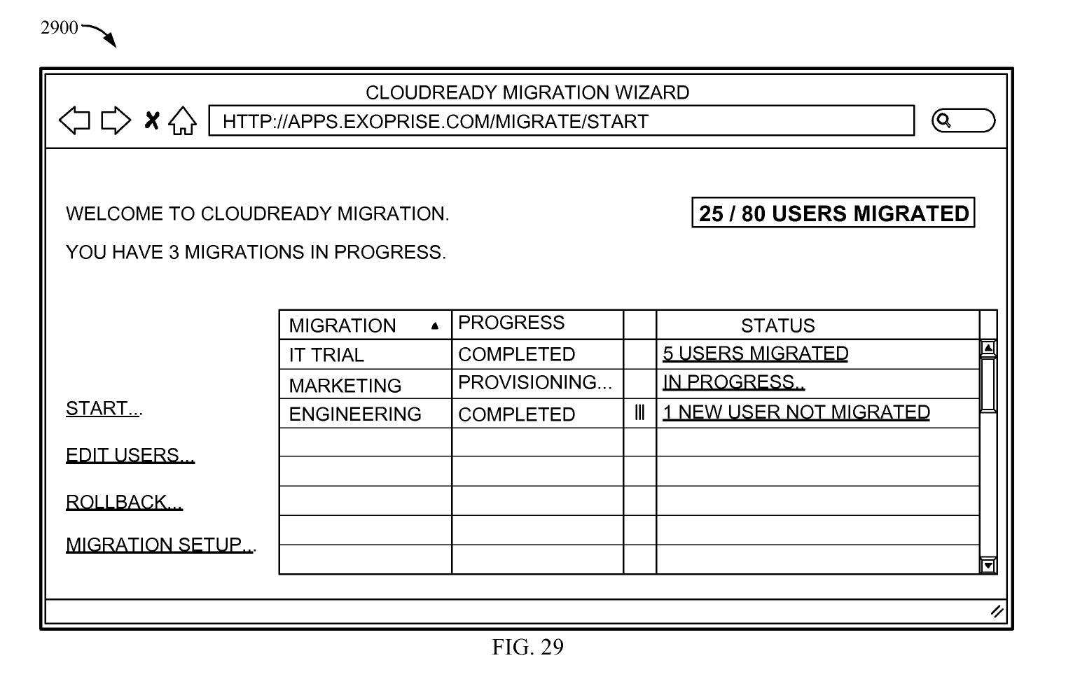

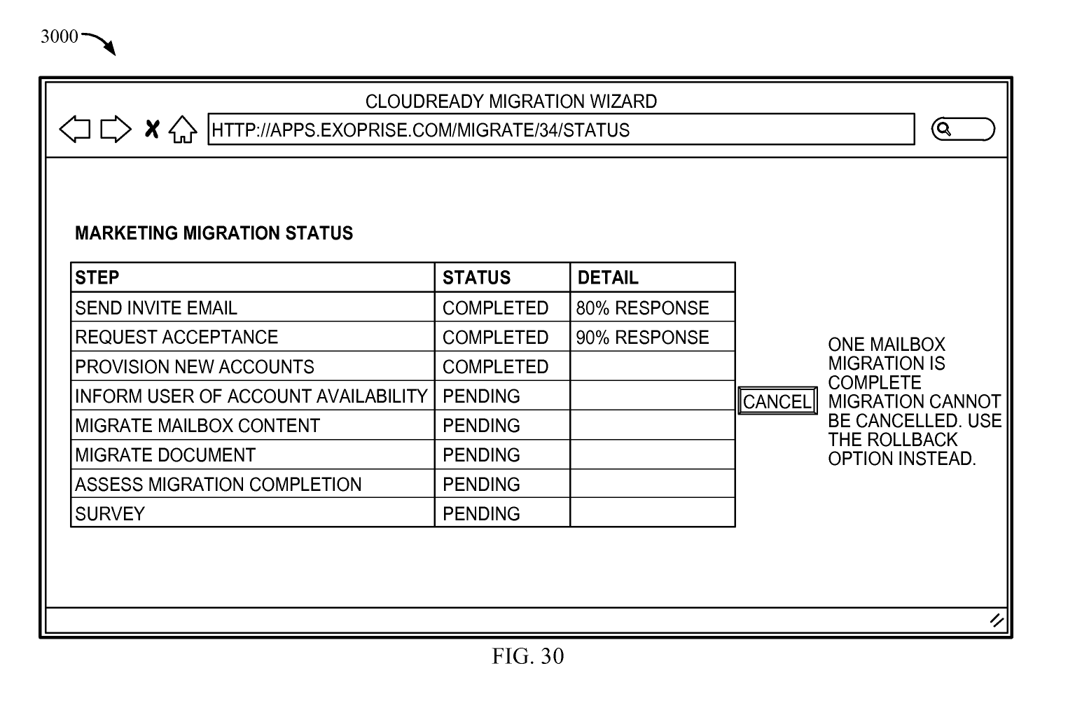

Referring now to FIGS. 29-30, exemplary user interfaces for monitoring concurrent migrations, used in tandem with the method of FIG. 13, are shown and described. FIG. 29 is an exemplary user interface 2900 depicting the progress of three concurrent migrations. FIG. 30 is an exemplary user interface 3000 depicting the progress of tasks within a migration.

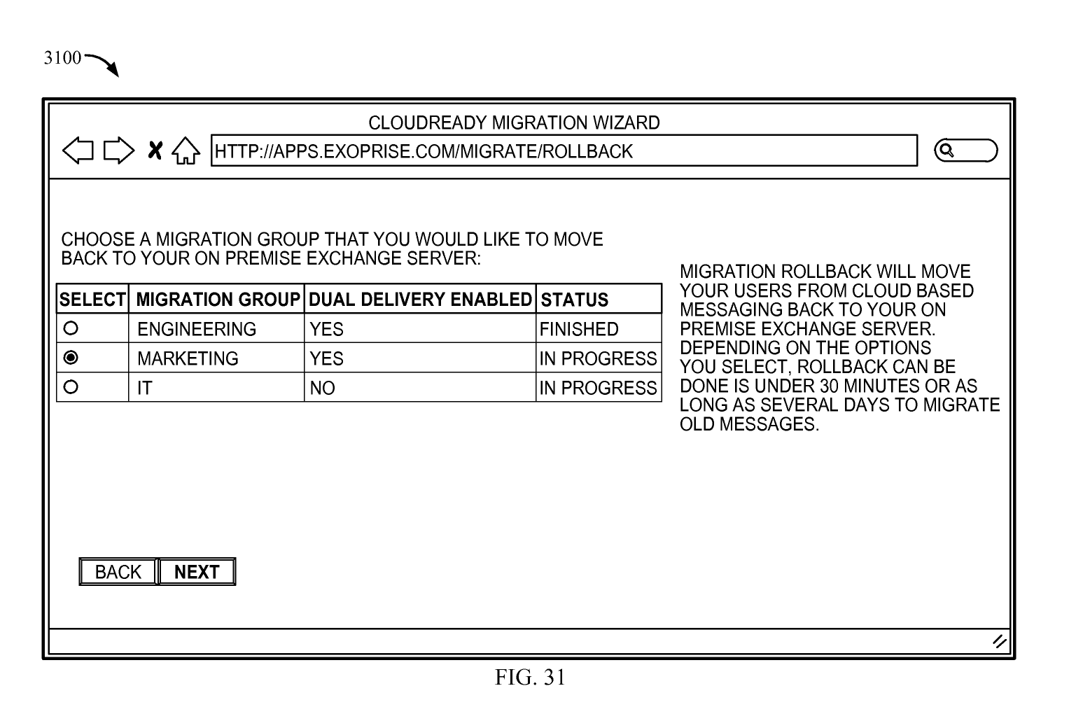

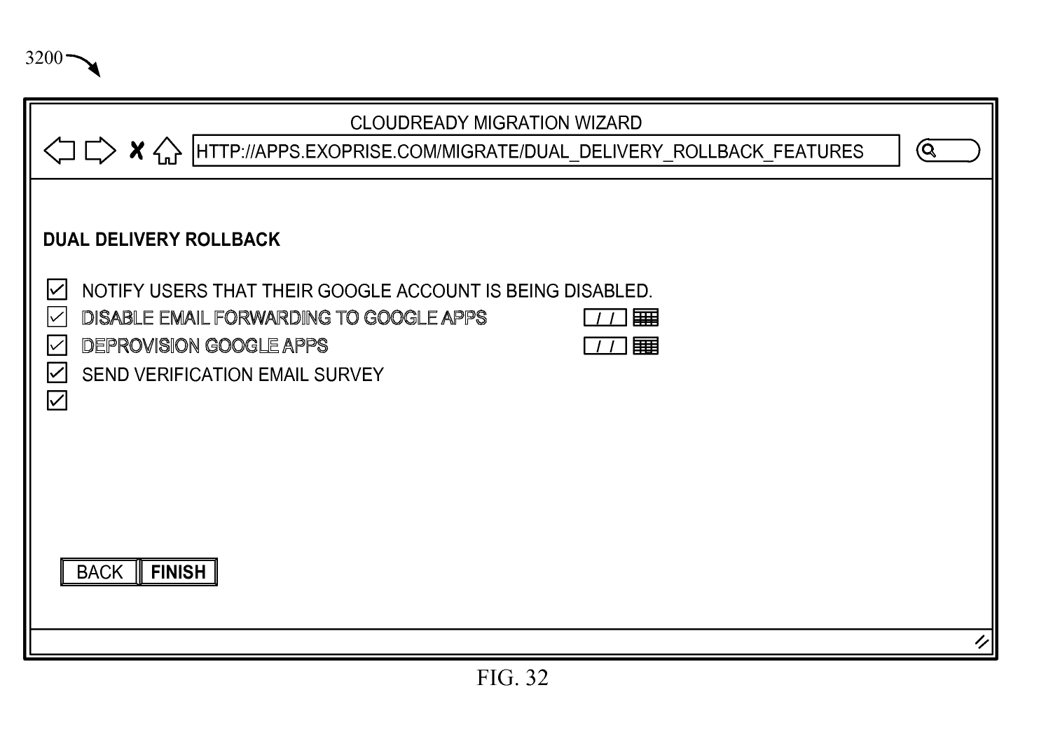

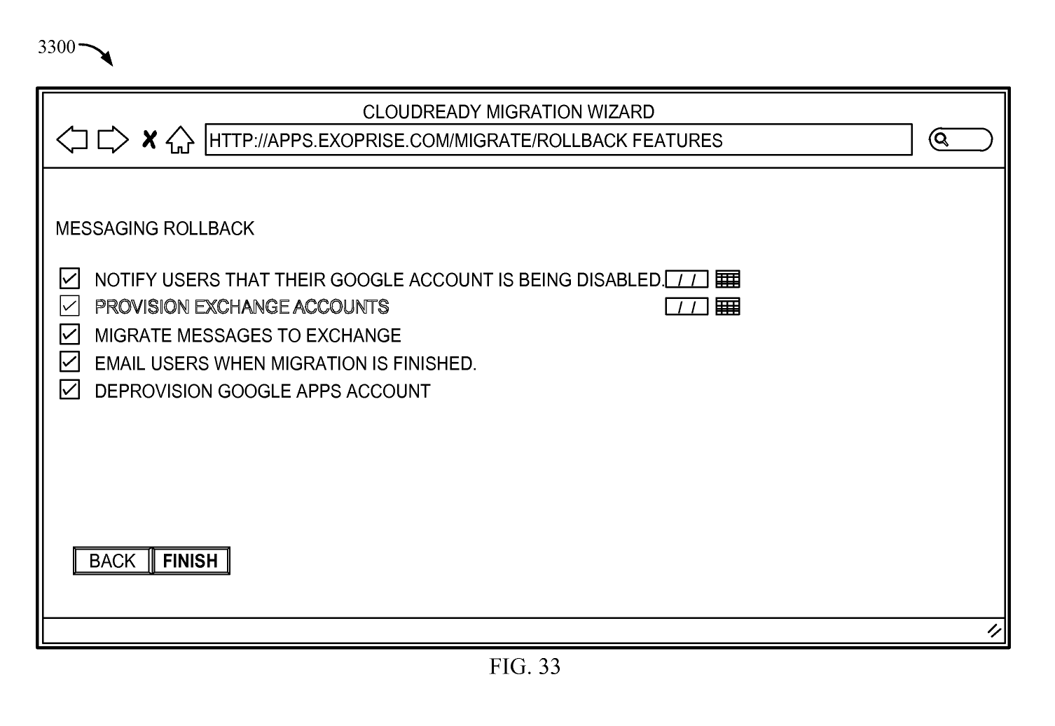

Referring now to FIGS. 31-33, exemplary user interfaces for rolling back migrations, used in tandem with the method of FIG. 13, are shown and described. FIG. 31 is an exemplary user interface 3100 for selecting a migration to roll back to the original computing infrastructure 112. FIGS. 32-33 are exemplary user interfaces 3200, 3300 for selecting features of the roll back.

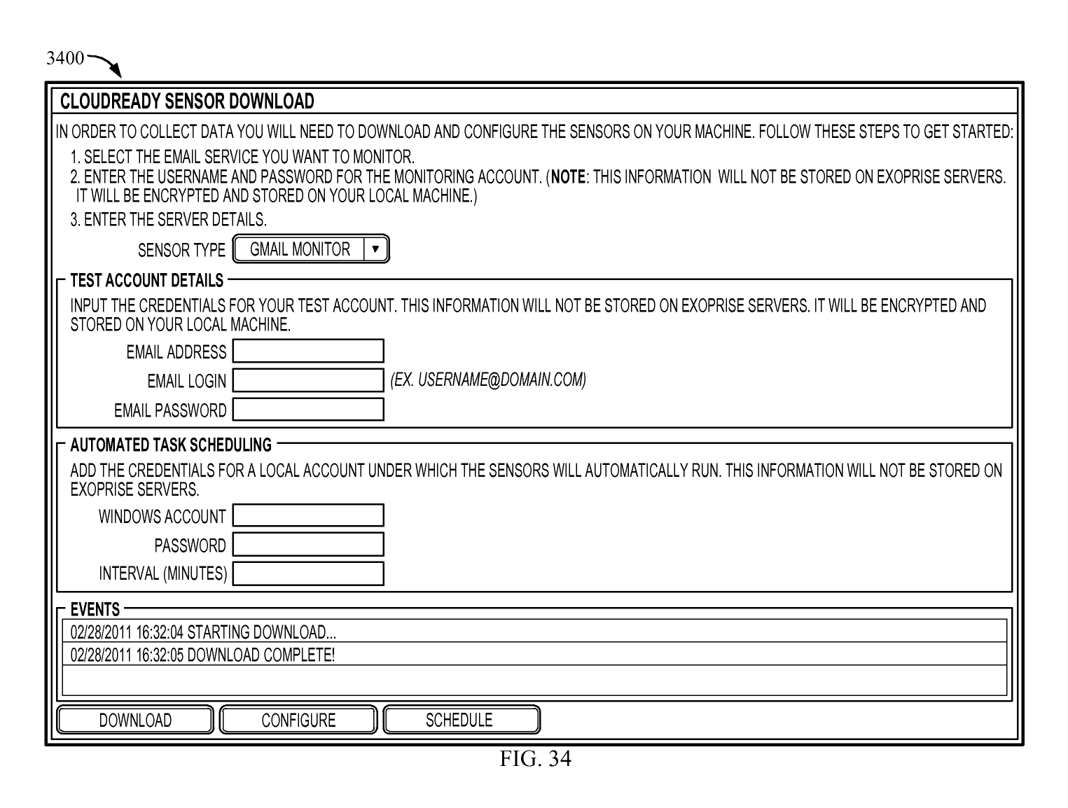

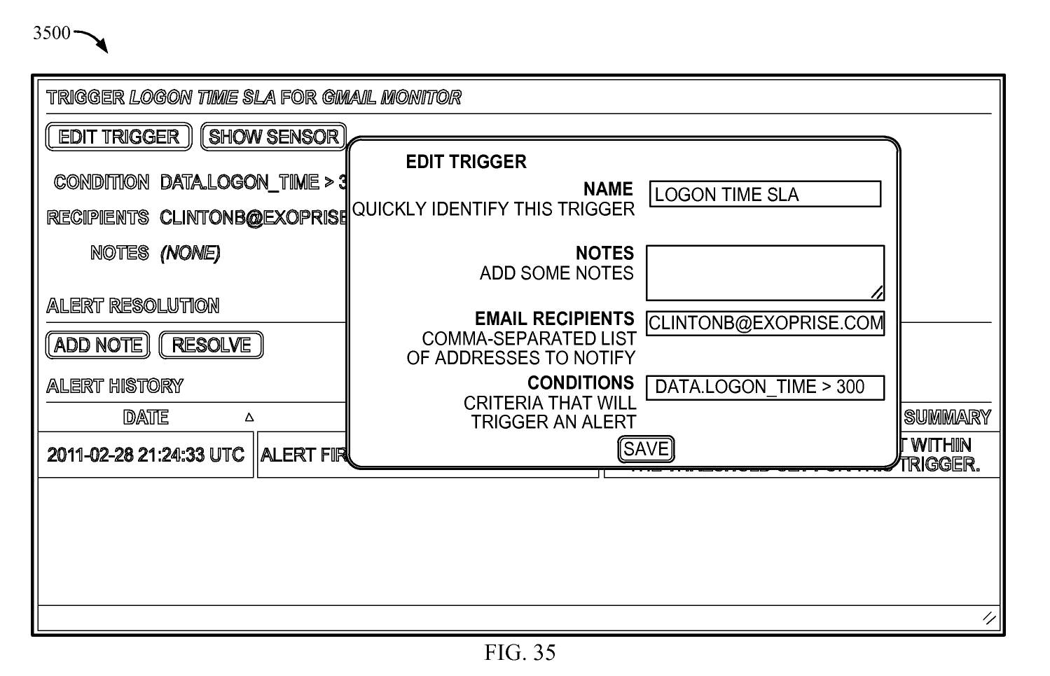

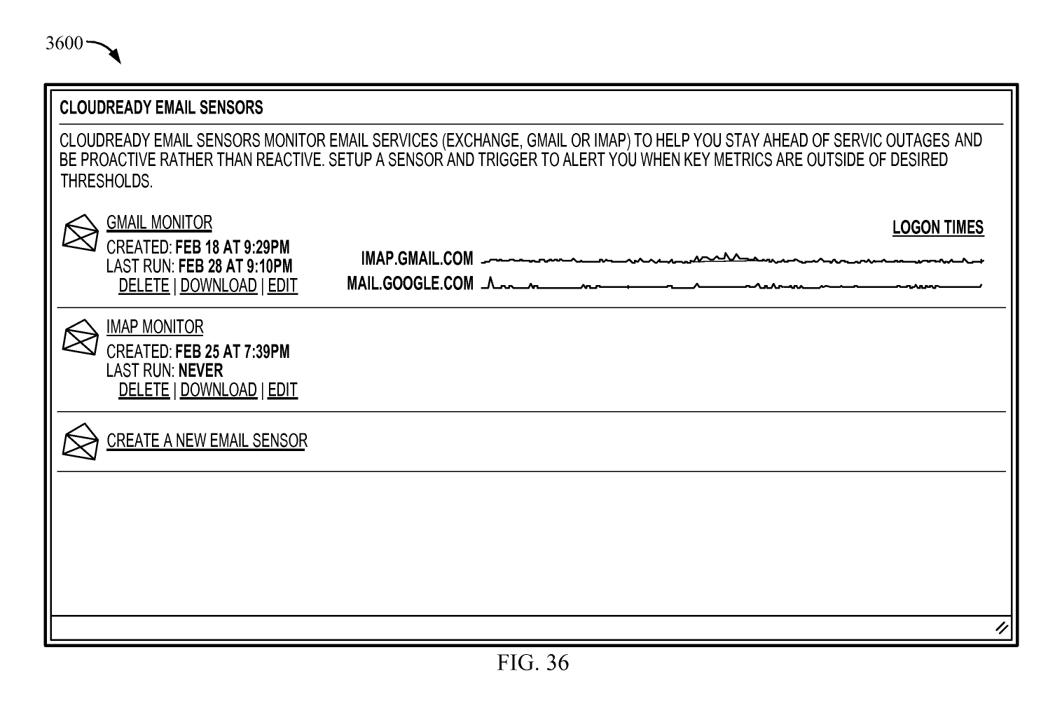

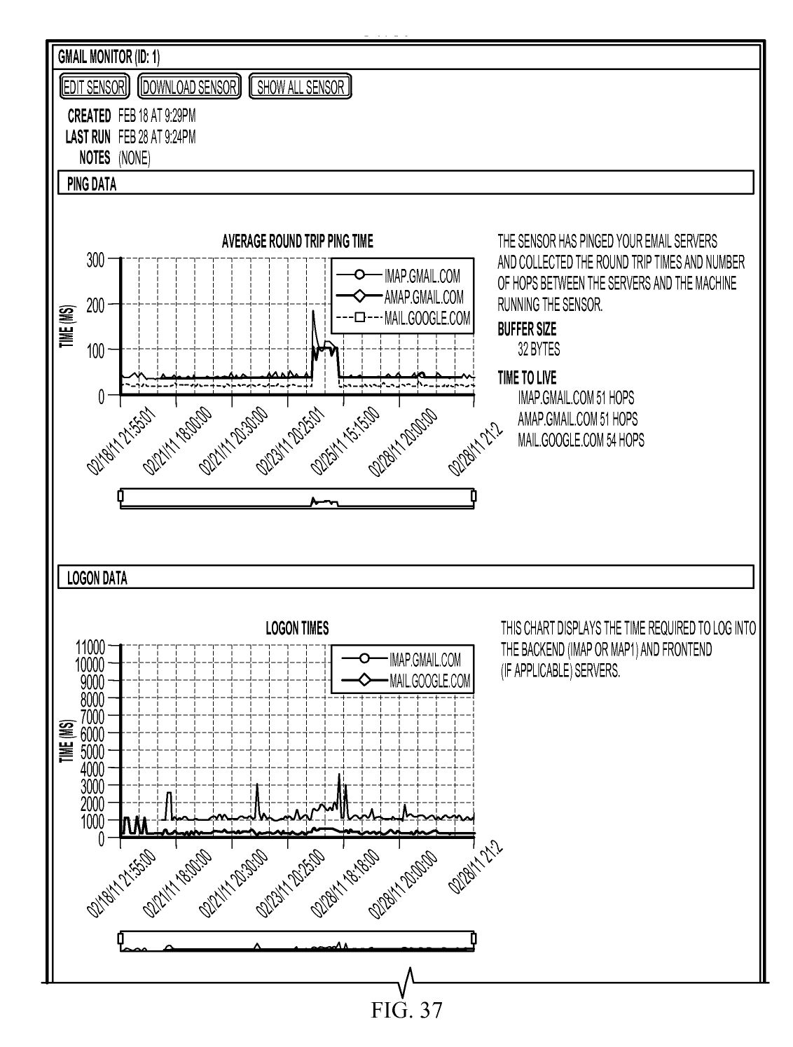

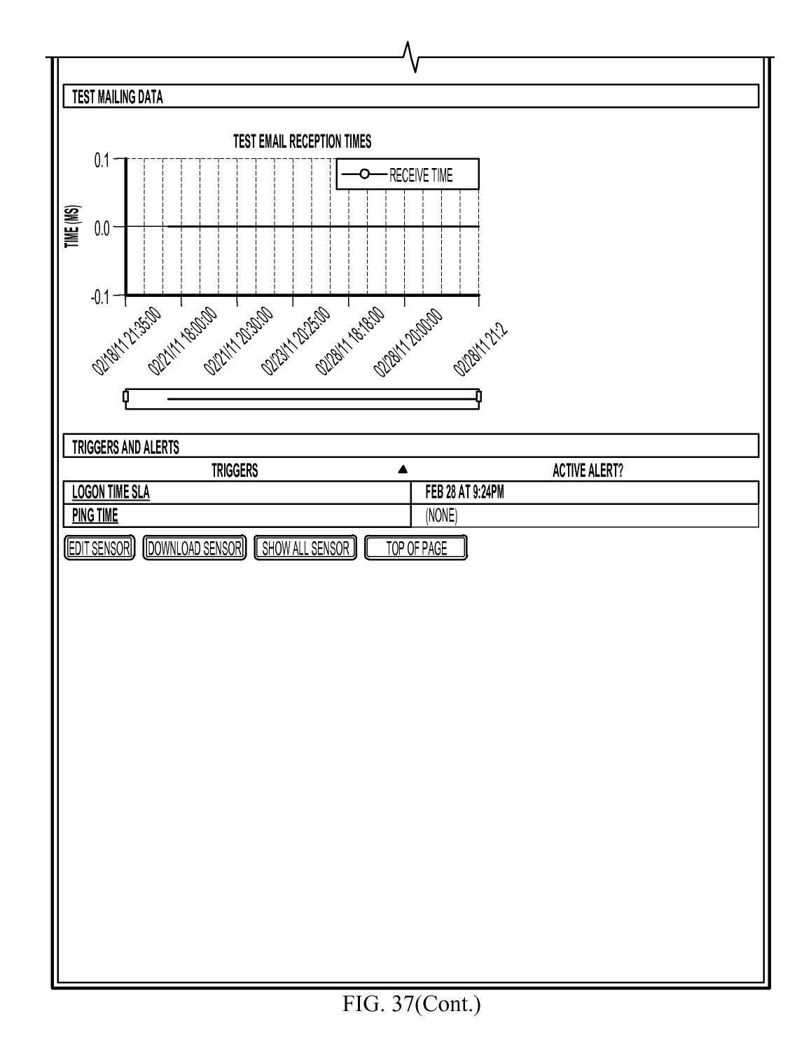

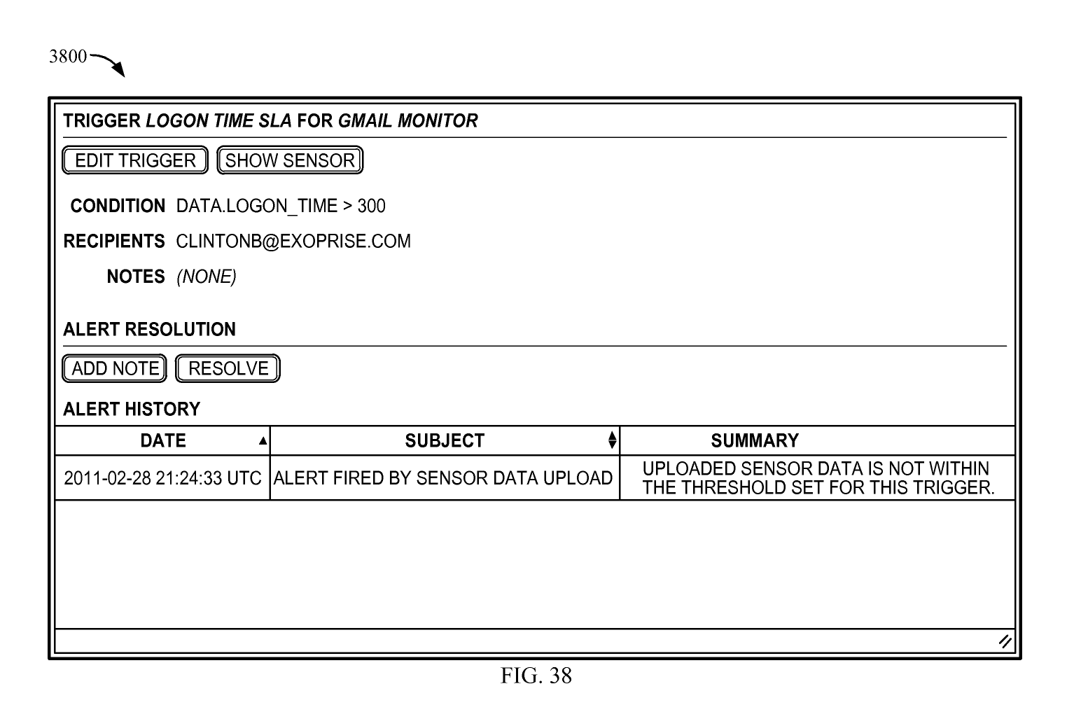

Referring now to FIGS. 34-38, exemplary user interfaces for configuring monitors for the infrastructures 112, 125 and/or viewing data obtained by monitoring are shown and described. FIG. 34 is an exemplary user interface 3400 for creating a monitor for an e-mail service. FIG. 35 is an exemplary user interface 3500 for configuring a monitor for an e-mail service. FIGS. 36-37 are exemplary user interfaces 3600, 3700 that display data obtained by monitoring an e-mail service. FIG. 38 is an exemplary user interface 3800 that displays records of actions taken in response to data obtained by monitoring.

While various embodiments of the methods and systems have been described, these embodiments are exemplary and in no way limit the scope of the described methods or systems. Those having skill in the relevant art may effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

1-21. (canceled)

22. A method comprising:
obtaining, via a network from an agent application executing within a third party computing system, data regarding a computing infrastructure of the third party computing system, wherein the data comprises one or more of
information about a plurality of hardware resources within the third party computing system,
information about organizational units within the third party computing system,
information about messaging,
information about use accounts,
information about a plurality of third party software applications installed within the computing infrastructure, and
information about security policies of the computing infrastructure;
calculating by a processor of a computing device, a plurality of metrics derived from the data, wherein the plurality of metrics comprise one or more of
information about usage of the computing infrastructure,
information about reliability of the computing infrastructure,
information about cost estimates of the computing infrastructure, and
information about security of the computing infrastructure;
evaluating, by the processor, at least a portion of the plurality of metrics in light of corresponding metrics associated with one or more alternative computing infrastructure configurations; and
determining, by the processor, responsive to evaluation, a recommendation.

23. The method of claim 22, further comprising preparing, by the processor, for review by a member of an organization comprising the third party computing system, report data regarding evaluation of the portion of the plurality of metrics.

24. The method of claim 22, wherein the agent application comprises one of a plug-in for a web browser and an application installed upon a server of the computing infrastructure.

25. The method of claim 22, wherein the agent application is configured to access two or more of processes, files, archives, registries, and network stacks.

26. The method of claim 22, wherein obtaining data regarding the computing infrastructure of the third party computing system comprises obtaining data from two or more agent applications.

27. The method of claim 22, wherein the data comprises a configuration of servers within the computing infrastructure.

28. The method of claim 22, wherein the data comprises information regarding organizational units for a third party organization, wherein the third party organization comprises the computing infrastructure.

29. The method of claim 28, wherein the data is organized according to organizational unit.

30. The method of claim 22, wherein
the agent application is configured to perform one or more synthetic transactions; and
obtaining data regarding the computing infrastructure of the third party computing system comprises obtaining data regarding a particular synthetic transaction of the one or more synthetic transactions.

31. A system comprising:
a processor; and
a memory having instructions stored thereon, wherein the instructions, when executed by the processor, cause the processor to:
obtain, via a network from an agent application executing within a third party computing system, data regarding a plurality of synthetic transactions performed in a computing infrastructure of the third party computing system, wherein the plurality of synthetic transactions comprise
one or more synthetic transactions within the third party computing systems, and
one or more synthetic transactions performed between the third party computing system and a target cloud provider;
calculate, by a processor of a computing device, a plurality of metrics derived from the data, wherein the plurality of metrics comprise one or more of
information about usage of at least one of the computing infrastructure and the target cloud provider,
information about reliability of at least one of the computing infrastructure and the target cloud provider,
information about cost estimates of at least one of the computing infrastructure and the target cloud provider, and
information about security of at least one of the computing infrastructure and the target cloud provider; and
preparing, by the processor, for review by a member of an organization comprising the third party computing system, report data regarding at least a portion of the plurality of metrics.

32. The system of claim 31, wherein the data regarding the plurality of synthetic transactions comprises one or more of a success rate, a time period, and a response time.

33. The system of claim 31, wherein the plurality of synthetic transactions are part of a test for detection of one or more of network bandwidth, network latency, and service unavailability.

34. The system of claim 31, wherein at least one synthetic transaction of the plurality of synthetic transactions comprises simulating user activity within a user account.

35. The system of claim 31, wherein at least one synthetic transaction of the plurality of synthetic transactions involves transmitting an electronic communication from the third party computing system to the target cloud provider.

36. The system of claim 35, wherein the instructions further cause the processor to:
access an account on the target cloud provider; and
verify arrival of the electronic communication.

37. The system of claim 35, wherein the instructions further cause the processor to:
access an account on the target cloud provider;
identify failure of arrival of the electronic communication within a predetermined period of time; and
issue, to a user account within the third party computing system, a notification regarding timeout of the electronic communication.

38. The system of claim 31, wherein at least one synthetic transaction of the plurality of synthetic transactions involves simulating user activity involving a chat application or voice messaging service.

39. A non-transitory memory having instructions stored thereon, wherein the instructions, when executed, cause a processor to:
obtain, via a network from a plurality of agent applications executing within a third party computing system, data regarding a computing infrastructure of the third party computing system, wherein
the data comprises one or more of a) information about a plurality of hardware resources within the third party computing system, b) information about organizational units within the third party computing system, c) information about messaging, d) information about use accounts, e) information about a plurality of third party software applications installed within the computing infrastructure, and f) information about security policies of the computing infrastructure, and
the plurality of agent applications comprise two or more of i) a remote shell, ii) an extension for a web browser, iii) a software application installed upon a server in the computing infrastructure, and iv) a software application installed upon a server on a virtual private network server accessed by the computing infrastructure;
calculating by a processor of a computing device, a plurality of metrics derived from the data, wherein the plurality of metrics comprise one or more of
information about usage of the computing infrastructure,
information about reliability of the computing infrastructure,
information about cost estimates of the computing infrastructure, and
information about security of the computing infrastructure; and
providing, by the processor, for review by a member of an organization comprising the third party computing system, report data regarding at least a portion of the plurality of metrics.

40. The memory of claim 39, wherein the instructions further cause the processor to, prior to providing the report data, aggregate the report data regarding the portion of the plurality of metrics with historical report data.

41. The memory of claim 40, wherein the historical report data comprises report data regarding the computing infrastructure gathered over a predetermined period of time.

42. The memory of claim 41, wherein aggregating the report data comprises identifying at least one of a) a number of users added over the predetermined period of time, b) a number of users removed over the period of time, c) an average time between failures during the period of time, d) a rate of growth of storage needs over the predetermined period of time, e) an up-time during the period of time, and f) a down-time during the period of time.
